(19) United States
(12) Patent Application Publication
(10) Pub. No.: US 2026/0209578 A1
(43) Pub. Date: Jul. 23, 2026

(54) BLOCK-COPOLYMER-CONTAINING EPOXY-BASED ADHESIVE COMPOSITION, PRODUCTION METHOD THEREFOR, AND CURED OBJECT OF BLOCK-COPOLYMER-CONTAINING EPOXY-BASED ADHESIVE

(71) Applicants: AISIN CORPORATION, Kariya-shi, Aichi (JP); National University Corporation Tokai National Higher Education and Research System, Nagoya-shi, Aichi (JP)

(72) Inventors: Kazumasa SAKAGUCHI, Toyota-shi, Aichi (JP); Tatsuya KANO, Toyota-shi, Aichi (JP); Kazuo HATTORI, Toyota-shi, Aichi (JP); Yoshiro FUJII, Toyota-shi, Aichi (JP); Atsushi NORO, Nagoya-shi, Aichi (JP); Takato KAJITA, Nagoya-shi, Aichi (JP); Takenobu SAKAI, Nagoya-shi, Aichi (JP); Saya YAMADA, Nagoya-shi, Aichi (JP); Mio NISHIMOTO, Nagoya-shi, Aichi (JP)

(73) Assignees: AISIN CORPORATION, Kariya-shi, Aichi (JP); National University Corporation Tokai National Higher Education and Research System, Nagoya-shi, Aichi (JP)

(21) Appl. No.: 19/137,963

(22) PCT Filed: Dec. 1, 2023
(86) PCT No.: PCT/JP2023/043061

§ 371 Date: Jun. 11, 2025

(30) Foreign Application Priority Data
Dec. 14, 2022 (JP) 2022-199053

(51) Int. Cl. C09J 153/02; C08G 59/24; C08G 59/40; C08K 3/26; C08K 3/36; C08K 5/17; C09J 163/00

(52) U.S. Cl. CPC C09J 153/02; C08G 59/245; C08G 59/4021; C08K 3/36; C08K 5/17; C09J 163/00; C08K 2003/265

(57) ABSTRACT

The present invention makes it possible to improve toughness.

This block-copolymer-containing epoxy-based adhesive composition comprises an epoxy resin, a hardener, and a block copolymer comprising a hydrocarbon-based rubbery polymer incompatible with the epoxy resin and having a glass transition temperature of 25° C. or lower and a polymer compatible with the epoxy resin.

### CROSS REFERENCE TO RELATED APPLICATIONS

This application is a National Stage of International Application No. PCT/JP2023/043061 filed Dec. 1, 2023, claiming priority based on Japanese Patent Application No. 2022-199053 filed Dec. 14, 2022.

### TECHNICAL FIELD

The present disclosure relates to a block-copolymer-containing epoxy-based adhesive composition, a method of producing the block-copolymer-containing epoxy-based adhesive composition, and a cured block-copolymer-containing epoxy-based adhesive, applicable to adhesives such as structural adhesives for automobile. In particular, the present disclosure relates to a block-copolymer-containing epoxy-based adhesive composition, a method of producing the block-copolymer-containing epoxy-based adhesive composition, and a cured block-copolymer-containing epoxy-based adhesive, enabling improvement in toughness.

### BACKGROUND ART

From the viewpoint of reduction in environmentally hazardous substances, technologies for reducing vehicle weight are actively being developed to achieve low fuel consumption and low exhaust gas in the field of automobiles and other vehicles. For example, in automobile body panels, there have been attempts to reduce the thickness of steel sheet and use low specific gravity materials such as aluminum and resins as part of a multi-material structure, in order to reduce weight.

Unfortunately, reducing the thickness of steel sheets used in automobile body panels to reduce weight decreases in their strength. Thus, to achieve a combination of weight reduction with high strength in body panels, surface bonding technologies using adhesives combined with spot welding for bonding steel plates have been developed.

Spot welding, which has been used for bonding steel plates, is unsuitable for materials other than steel plates. Thus, adhesives have been known to be used for multi-materials bonding, such as aluminum and resin bonding.

In bonding areas where spot welding cannot be applied, thermosetting epoxy adhesives containing a thermosetting epoxy resin with high shear strength and peel strength have been used.

Unfortunately, cured epoxy resins are inflexible, hard, and brittle. One-component epoxy resins, despite exhibiting high shear adhesion, are poor in stretchability and flexibility, and thus tend to exhibit low peel adhesive strength and low impact adhesive strength.

To improve the toughness of epoxy resins, modification using core-shell rubber particles has been known, as disclosed in Patent Literature 1.

### CITATION LIST

### Patent Literature

PTL1: Japanese Unexamined Patent Application Publication No. 5-065491

### SUMMARY OF THE DISCLOSURE

### Technical Problem

Unfortunately, in the modification using core-shell rubber particles, the epoxy resin, when curing, exhibits phase separation, forming rubber domains, the dimensions of which depend on the curing conditions. This results in inconsistent product quality. Further, the rubber-like polymer core is covered with a shell such as an acrylic copolymer shell. This leads to a low content of the rubber-like polymer core, making it difficult to achieve a combination of easy application and improved toughness. Furthermore, the core-shell rubber particles are expensive to produce due to labor-intensive preparing processes.

It is an aspect of the present disclosure to provide a block-copolymer-containing epoxy-based adhesive composition, a method of producing the block-copolymer-containing epoxy-based adhesive composition, and a cured block-copolymer-containing epoxy-based adhesive, to enable improvement in toughness.

### Solution to Problem

A block-copolymer-containing epoxy-based adhesive composition according to a first aspect of the present disclosure contains an epoxy resin, a curing agent, and a block copolymer having a hydrocarbon-based rubber-like polymer that is incompatible with the epoxy resin and has a glass transition temperature of 25° C. or lower, and having a polymer that is compatible with the epoxy resin.

As the epoxy resin, a general-purpose epoxy resin such as a bisphenol A type epoxy resin or a bisphenol F type epoxy resin, an urethane modified epoxy resin, and a rubber modified epoxy resin can be used. Preferred epoxy resin is a general-purpose epoxy resin such as a bisphenol A type epoxy resin.

As the curing agent, any compounds having an active group reacting with an epoxy group can be used. Preferred examples of the curing agent include latent curing agent such as imidazole compound or dicyandiamide, which exhibits excellent storage stability.

The block copolymer is of different types of polymers chemically bonded together: one being a hydrocarbon-based rubber-like polymer that is incompatible with the epoxy resin and has a glass transition temperature (T_{g}) of 25° C. or lower, the other being a polymer that is compatible with the epoxy resin.

The hydrocarbon-based rubber-like polymer having a glass transition temperature (T_{g}) of 25° C. or lower in the block copolymer is a polymer that has carbon atoms (C) and hydrogen atoms (H) and has a glass transition temperature (T_{g}) below room temperature, and serves as a soft segment at room temperature. The glass transition temperature (T_{g}) varies depending on the type of rubber-like polymer. The lower limit of the glass transition temperature (T_{g}) is approximately −120° C., which is a finite value.

The term “rubber-like” in the hydrocarbon-based rubber-like polymer as used herein means that the segment having a glass transition temperature (T_{g}) of 25° C. or lower in the block copolymer behaves as a soft segment at room temperature The soft segment exhibits active segment motion (micro-Brownian motion), whereas a hard segment exhibits substantially no segment motion. A segment refers to a unit involved in polymer chain motion and consists of several to several tens of monomer units.

The polymer that is compatible with the epoxy resin in the block copolymer is a segment (i.e., block) having a glass transition temperature (T_{g}) higher than room temperature and serves a hard segment at room temperature. The glass transition temperature (T_{g}) is determined by differential scanning calorimetry (DSC) in accordance with JIS K 6240, 2011.

Examples of the block copolymer include hydrogenated or non-hydrogenated thermoplastic styrenic elastomer, such as a polystyrene-polyisoprene-polystyrene block copolymer (SIS), a polystyrene-poly(ethylene-propylene)-polystyrene block copolymer (SEPS), which is a hydrogenated SIS, a polystyrene-polybutadiene-polystyrene block copolymer (SBS), a polystyrene-poly(ethylene-butylene)-polystyrene block copolymer (SEBS), which is a hydrogenated SBS, and thermoplastic styrenic elastomer having a polyisobutylene, such as a polystyrene-polyisobutylene-polystyrene block copolymer (SIBS).

In the block-copolymer-containing epoxy-based adhesive composition according to the first aspect, the hydrocarbon-based rubber-like polymer in the block copolymer may have a monomer unit composed of isoprene, butadiene, hydrogenated isoprene, or hydrogenated butadiene. Further, the polymer that is compatible with the epoxy resin may have a monomer unit with a styrene moiety, a methacrylic moiety, an acryl moiety, or an ether moiety.

The isoprene monomer unit is derived from the polymerization of isoprene, CH₂—C(CH₃)—CH═CH₂ and is represented by the chemical formula, for example, —CH₂—C(CH₃)=CH—CH₂—.

The hydrogenated isoprene monomer unit is derived from the hydrogenation of the double bond in the isoprene monomer unit and is represented by the chemical formula, for example, —CH₂—C(CH₃)—CH₂—CH₂—.

The butadiene monomer unit is derived from the polymerization of butadiene, CH₂═CH—CH—CH₂, and is represented by the chemical formula, for example, —CH₂—CH═CH—CH₂— or —CH₂—CH(CH═CH₂)—.

The hydrogenated butadiene monomer unit is derived from the hydrogenation of the double bond in the butadiene monomer unit and is represented by the chemical formula, for example, —CH₂—CH₂—CH₂—CH₂— or —CH₂—CH(CH₂—CH₃)—.

The styrene moiety is represented by the chemical formula, —CH₂—CH(C₆H₄R)—, when R represents hydrogen or organic functional group. The methacrylic moiety is represented by the chemical formula, —CH₂—C(CH₃)(COOR)—, when R represents hydrogen or organic functional group. The acryl moiety is represented by the chemical formula, —CH₂—CH(COOR)—, when R represents hydrogen or organic functional group. The ether moiety is represented by the chemical formula, —(CH₂)ₙ—O—, when n represents a natural number of one to eight.

In the block-copolymer-containing epoxy-based adhesive composition according to the first aspect, the content of hydrocarbon-based rubber-like polymer in the block copolymer is preferably in the range of 0.5 to 3000 parts by weight, more preferably in the range of 0.7 to 2800 parts by weight, further preferably in the range of 2.0 to 2600 parts by weight, particularly preferably in the range of 3.0 to 2500 parts by weight, per 100 parts by weight of the epoxy resin.

In the block-copolymer-containing epoxy-based adhesive composition according to the first aspect, the level of the polymer being compatible with the epoxy resin in the block copolymer is preferably in the range of 3 to 80 mass %, more preferably in the range of 5 to 70 mass %, further preferably in the range of 10 to 50 mass %.

In the block-copolymer-containing epoxy-based adhesive composition according to the first aspect, the polymer being compatible with the epoxy resin in the block copolymer preferably have a number average molecular weight (Mn) of 1,000 to 50,000, more preferably 1,000 to 40,000, and further preferably 1,500 to 30,000. The molecular weight corresponds to a molecular weight of a polymer block unit. The number average molecular weight (Mn) is determined by gel permeation chromatography (GPC) using standard polystyrene.

In the block-copolymer-containing epoxy-based adhesive composition according to the first aspect, the content of the block copolymer is preferably in the range of 0.5 to 3500 parts by weight, more preferably in the range of 0.8 to 3400 parts by weight, further preferably in the range of 2 to 3200 parts by weight, particularly preferably in the range of 5 to 3000 parts by weight, per 100 parts by weight of the epoxy resin.

In the block-copolymer-containing epoxy-based adhesive composition according to the first aspect, the block copolymer may be a thermoplastic styrenic elastomer or a hydrogenated thermoplastic styrenic elastomer.

As the thermoplastic styrenic elastomer (TPS), a polystyrene-polyisoprene-polystyrene block copolymer (SIS) or polystyrene-polybutadiene-polystyrene block copolymer (SBS) can be used.

As the hydrogenated thermoplastic styrenic elastomer, a polystyrene-poly(ethylene-propylene)-polystyrene block copolymer (SEPS) or a polystyrene-poly(ethylene-butylene)-polystyrene block copolymer (SEBS) can be used.

The example of the structural formula of the polystyrene-polyisoprene-polystyrene block copolymer (SIS) is shown in Chem. 1. The example of the structural formula of the polystyrene-polybutadiene-polystyrene block copolymer (SBS) is shown in Chem. 2. The example of the structural formula of the polystyrene-poly(ethylene-propylene)-polystyrene block copolymer (SEPS) is shown in Chem. 3. The example of the structural formula of the polystyrene-poly(ethylene-butylene)-polystyrene block copolymer (SEBS) is shown in Chem. 4.

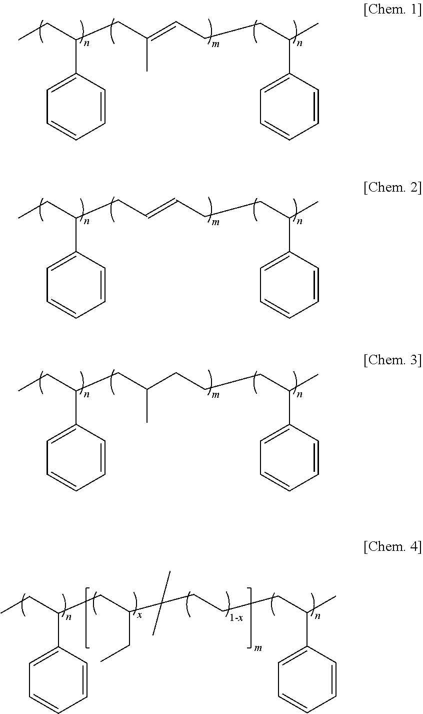

A block-copolymer-containing epoxy-based adhesive composition according to a second aspect of the present disclosure contains an epoxy resin, a curing agent, and a polystyrene-polyisoprene-polystyrene block copolymer or a hydrogenated polystyrene-polyisoprene-polystyrene block copolymer.

The polystyrene-polyisoprene-polystyrene block copolymer (SIS) has a polystyrene block at the both ends, which serves as a hard segment at room temperature, and a polyisoprene block at the middle, which serves a soft segment at room temperature.

The hydrogenated polystyrene-polyisoprene-polystyrene block copolymer (hydrogenated SIS), in which the polyisoprene block is hydrogenated, is a polystyrene-poly(ethylene-propylene)-polystyrene block copolymer (SEPS). A block-copolymer-containing epoxy-based adhesive composition according to a third aspect of the present disclosure contains an epoxy resin, a curing agent, and a polystyrene-polybutadiene-polystyrene block copolymer or a hydrogenated polystyrene-polybutadiene-polystyrene block copolymer.

The polystyrene-polybutadiene-polystyrene block copolymer (SBS) has a polystyrene block at the both ends, which serve as a hard segment at room temperature, and a polybutadiene block at the middle, which serves a soft segment at room temperature.

The hydrogenated polystyrene-polybutadiene-polystyrene (hydrogenated SBS), in which the polybutadiene block is hydrogenated, is a polystyrene-poly(ethylene-butylene)-polystyrene block copolymer (SEBS).

A method of producing a block-copolymer-containing epoxy-based adhesive composition according to a fourth aspect of the present disclosure is a method of producing an epoxy adhesive composition containing an epoxy resin, a curing agent, and a block copolymer having a hydrocarbon-based rubber-like polymer that is incompatible with the epoxy resin and has a glass transition temperature of 25° C. or lower, and having a polymer that is compatible with the epoxy resin. The method of producing the epoxy adhesive composition includes a mixing step of mixing at least two components, the epoxy resin and the block copolymer, with a solvent and the solvent removal step of removing the solvent.

The term “mixing at least two components, the epoxy resin and the block copolymer, with a solvent” is intended to encompass the curing agent and an addictive may be mixed in the mixing step. Alternatively, the curing agent and the addictive may be mixed after the solvent removal step.

Examples of the solvent include, tetrahydrofuran (THF) 2-methyltetrahydrofuran, toluene, acetone, cyclohexane, n-hexane, ethyl acetate, methanol, dichloromethane (methylene chloride), methyl ethyl ketone (MEK), butyl acetate, methylcyclohexane (MCH), N,N-dimethylformamide (DMF), and N-methyl-2-pyrrolidone (NMP).

A cured block-copolymer-containing epoxy-based adhesive according to a fifth aspect of the present disclosure is a thermally cured product of an epoxy adhesive composition containing an epoxy resin, a curing agent, and a block copolymer having a hydrocarbon-based rubber-like polymer that is incompatible with the epoxy resin and has a glass transition temperature of 25° C. or lower, and having a polymer that is compatible with the epoxy resin.

### Advantageous Effects of Various Aspects of the Disclosure

A block-copolymer-containing epoxy-based adhesive composition according to a first aspect of the present disclosure contains an epoxy resin, a curing agent, and a block copolymer having a hydrocarbon-based rubber-like polymer that is incompatible with the epoxy resin and has a glass transition temperature of 25° C. or lower, and having a polymer that is compatible with the epoxy resin. In the block copolymer, the polymer that has compatibility with the epoxy resin is compatible with the epoxy resin, while the hydrocarbon-based rubber-like polymer is incompatible with the epoxy resin. As a result, the hydrocarbon-based rubber-like polymer provides stretchability, flexibility, and elasticity, enabling improvement in toughness.

In the block-copolymer-containing epoxy-based adhesive composition according to the first aspect, the hydrocarbon-based rubber-like polymer may have a monomer unit composed of isoprene, butadiene, hydrogenated isoprene, or hydrogenated butadiene, and the polymer that is compatible with the epoxy resin may have a monomer unit with a styrene moiety, a methacrylic moiety, an acryl moiety, or an ether moiety. This composition enables improvement in properties such as rubber elasticity, heat aging resistance, and weather resistance, in addition to the above-described advantageous effect.

In the block-copolymer-containing epoxy-based adhesive composition according to the first aspect, the hydrocarbon-based rubber-like polymer in the block copolymer may be present in an amount of 0.5 to 3000 parts by weight relative to 100 parts by weight of the epoxy resin. This composition enables enhancement of toughness and durability. Thus, the composition can provide highly reliable adhesive strength even when used for bonding dissimilar materials, in addition to the above-described advantageous effect.

In the block-copolymer-containing epoxy-based adhesive composition according to the first aspect, the polymer that is compatible with the epoxy resin in the block copolymer may be present in an amount 3 to 80 mass %. This composition enables enhancement of compatibility with the epoxy resin and homogenously blending with the epoxy resin, thereby providing the cured adhesive having stable properties, in addition to the above-described advantageous effect.

In the block-copolymer-containing epoxy-based adhesive composition according to the first aspect, the polymer that is compatible with the epoxy resin in the block copolymer may have a number average molecular weight ranging from 1,000 to 5,000. This composition enables enhancement of compatibility with the epoxy resin and homogenously blending with the epoxy resin, thereby providing the cured adhesive having stable properties, in addition to the above-described advantageous effect.

In the block-copolymer-containing epoxy-based adhesive composition according to the first aspect, the block copolymer may be present in an amount of 1 to 3000 parts by weight, per 100 parts by weight of the epoxy resin. This composition enables combination of easy application with improvement in toughening, in addition to the above-described advantageous effect.

In the block-copolymer-containing epoxy-based adhesive composition according to the first aspect, the block copolymer may be a thermoplastic styrenic elastomer or a hydrogenated thermoplastic styrenic elastomer, which is cheap and has higher stretchability, flexibility, and elasticity. This composition enables enhancement of toughening at low cost, in addition to the above-described advantageous effect.

A block-copolymer-containing epoxy-based adhesive composition according to a second aspect contains an epoxy resin, a curing agent, and a polystyrene-polyisoprene-polystyrene block copolymer or a hydrogenated polystyrene-polyisoprene-polystyrene block copolymer. In the polystyrene-polyisoprene-polystyrene block copolymer or the hydrogenated polystyrene-polyisoprene-polystyrene block copolymer, the polystyrene segment is compatible with the epoxy resin, while the polyisoprene segment or the hydrogenated polyisoprene segment is incompatible with the epoxy resin. As a result, the polyisoprene segment or the hydrogenated polyisoprene segment provides stretchability, flexibility, and elasticity, enabling improvement in toughness.

A block-copolymer-containing epoxy-based adhesive composition according to a third aspect contains an epoxy resin, a curing agent, and a polystyrene-polybutadiene-polystyrene block copolymer or a hydrogenated polystyrene-polybutadiene-polystyrene block copolymer. In the polystyrene-polybutadiene-polystyrene block copolymer or the hydrogenated polystyrene-polybutadiene-polystyrene block copolymer, the polystyrene segment is compatible with the epoxy resin, while the polybutadiene segment or the hydrogenated polybutadiene segment is incompatible with the epoxy resin. As a result, the polybutadiene segment or the hydrogenated polybutadiene segment provides stretchability, flexibility, and elasticity, enabling improvement in toughness.

A method of producing a block-copolymer-containing epoxy-based adhesive composition according to a fourth aspect is a method of producing an epoxy adhesive composition containing an epoxy resin, a curing agent, and a block copolymer having a hydrocarbon-based rubber-like polymer that is incompatible with the epoxy resin and has a glass transition temperature of 25° C. or lower, and having a polymer that is compatible with the epoxy resin. In the method of producing the epoxy adhesive composition, at least the epoxy resin and the block copolymer are mixed with a solvent in a mixing step and the solvent is removed in a solvent removal step to give an epoxy adhesive composition. In the epoxy adhesive obtained from the epoxy adhesive composition, the polymer having compatibility with the epoxy resin is compatible with the epoxy resin, while the hydrocarbon-based rubber-like polymer is incompatible with the epoxy resin. As a result, the hydrocarbon-based rubber-like polymer provides stretchability, flexibility, and elasticity, enabling improvement in toughness.

A cured block-copolymer-containing epoxy-based adhesive according to a fifth aspect is a cured product of an epoxy adhesive composition containing an epoxy resin, a curing agent, and a block copolymer having a hydrocarbon-based rubber-like polymer that is incompatible with the epoxy resin and has a glass transition temperature of 25° C. or lower, and having a polymer that is compatible with the epoxy resin. In the cured epoxy adhesive formed from the epoxy adhesive composition, the polymer having compatibility with the epoxy resin is compatible with the epoxy resin, while the hydrocarbon-based rubber-like polymer is incompatible with the epoxy resin. As a result, the hydrocarbon-based rubber-like polymer provides stretchability, flexibility, and elasticity, enabling improvement in toughness.

### BRIEF DESCRIPTION OF DRAWINGS

FIG. 1A schematically illustrates the molecular structure of a polystyrene-polyisoprene-polystyrene block copolymer (SIS), which is one example of a block copolymer having a hydrocarbon-based rubber-like polymer that is incompatible with the epoxy resin and has a glass transition temperature of 25° C. or lower, and having a polymer that is compatible with the epoxy resin. FIG. 1B schematically illustrates the polystyrene-polyisoprene-polystyrene block copolymers (SIS) exhibiting phase separation, which is one example of a block copolymer having a hydrocarbon-based rubber-like polymer that is incompatible with the epoxy resin and has a glass transition temperature of 25° C. or lower, and having a polymer that is compatible with the epoxy resin. FIG. 1C schematically illustrates the polystyrene-polyisoprene-polystyrene block copolymers (SIS) dispersed in a matrix of the epoxy resin, when the polystyrene-polyisoprene-polystyrene block copolymers (SIS), which is one example of a block copolymer having a hydrocarbon-based rubber-like polymer that is incompatible with the epoxy resin and has a glass transition temperature of 25° C. or lower, and a polymer that is compatible with the epoxy resin, is blended with the epoxy resin.

FIG. 2 is a ¹H-NMR spectrum of the block-copolymer-containing epoxy-based adhesive composition in the form of liquid according to Example 10 of the present embodiment.

FIG. 3 is optical microscope photographs for showing phase separation between polyisoprene and epoxy resin.

FIG. 4A is FT-IR spectra of the cured product of the block-copolymer-containing epoxy-based adhesive composition according to Example 36 of the present embodiment, the cured product of the epoxy adhesive composition according to Comparative Example 3, and a polystyrene-polyisoprene-polystyrene block copolymer (SIS). FIG. 4B is graphs showing loss tangent determined by dynamic mechanical analysis of the cured product of the block-copolymer-containing epoxy-based adhesive composition according to Example 36 of the present embodiment, the cured product of the epoxy adhesive composition according to Comparative Example 3, and a polystyrene-polyisoprene-polystyrene block copolymer (SIS).

FIG. 5A is a TEM image of the cured product of the epoxy adhesive composition according to Example 36. FIG. 5B is a TEM image of a polystyrene-polyisoprene-polystyrene block copolymer (SIS).

FIG. 6 is DSC thermograms of the cured product of the block-copolymer-containing epoxy-based adhesive composition according to Example 36 of the present embodiment, the cured product of the epoxy adhesive composition according to Comparative Example 3, and a polystyrene-polyisoprene-polystyrene block copolymer (SIS).

### DESCRIPTION OF EMBODIMENTS

An embodiment of the present disclosure will now be described.

A block-copolymer-containing epoxy-based adhesive composition (hereinafter sometimes referred to simply as “epoxy adhesive composition”) of the embodiment is a thermosetting epoxy resin composition containing an epoxy resin having at least two epoxy groups (oxirane rings) per molecule and a curing agent component having active hydrogen or catalytic activity. The epoxy adhesive composition further contains a block copolymer having a hydrocarbon-based rubber-like polymer that is incompatible with the epoxy resin and has a glass transition temperature of 25° C. or lower, and having a polymer that is compatible with the epoxy resin (hereinafter sometimes referred to simply as “block copolymer”).

The epoxy resin typically has at least two epoxy groups (including oxirane rings) per molecule and is cured using the curing agent to form a crosslinked product. Examples of the epoxy resin include bifunctional glycidyl ether-type epoxy resin; bisphenol type-epoxy compound having bisphenol A, bisphenol F, brominated bisphenol A, hydrogenated bisphenol A, bisphenol S, bisphenol AD, bisphenol AF, or biphenyl structure; glycol-type epoxy compound, e.g., polyalkylene glycol-type and alkylene glycol-type epoxy resin; epoxy compound having a naphthalene ring; and epoxy compound having a fluorene group;
novolac-type epoxy resin, such as phenolic novolac epoxy resin or orthocresol novolac epoxy resin;
multifunctional glycidyl ether-type epoxy resin, such as multifunctional glycidyl ether or tetraphenylolethane-type epoxy resin;
glycidyl ester-type epoxy resin derived from synthetic fatty acid such as dimer acid;
aromatic epoxy resin with a glycidylamino group, such as N,N,N′,N′-Tetraglycidyl-4,4′-diaminodiphenylmethane (TGDDM), tetraglycidyl-m-xylylene diamine, triglycidyl-p-aminophenol or, N,N-diglycidylaniline; epoxy compound having a tricyclodecane ring, which is obtained by reacting epichlorohydrin with a polymer of dicyclopentadiene and cresol (e.g., m-cresol) or phenol;
tris(hydroxyphenyl) methane-type epoxy resin; sorbitol-type epoxy resin; polyglycerol-type epoxy resin; glycidyl ester-type epoxy resin; heterocyclic epoxy resin; diaryl sulfone-type epoxy resin; pentaerythritol-type epoxy resin; and trimethylolpropane-type epoxy resin. As the epoxy resin, modified epoxy resin such as urethane-modified epoxy resin, dimer acid-modified epoxy resin, rubber-modified epoxy resin can also be used. Any urethane-modified epoxy resin having a urethane bond and at least two epoxy groups may be employed. To efficiently incorporate both urethane bonds and epoxy groups into one molecule, a preferred urethane-modified epoxy resin is one obtained by reacting a compound having an urethane bond derived from an isocyanate group with an epoxy compound with a hydroxy group. The rubber-modified epoxy resin has at least two epoxy groups and a rubber structure composed of polybutadiene, acrylonitrile butadiene rubber (NBR), or carboxyl-terminated butadiene acrylonitrile rubber (CTBN). The above-mentioned epoxy resins may be used in combination.

Such epoxy resins are cured through ring-opening polymerization, thereby resulting in smaller curing shrinkage than other thermosetting resins. Further, such epoxy resins have both hydrophilic and hydrophobic groups in the molecule and thus exhibit high adhesion to various adherends.

For higher compatibility with the block copolymer having the hydrocarbon-based rubber-like polymer that is incompatible with the epoxy resin and has a glass transition temperature of 25° C. or lower, and having the polymer that is compatible with the epoxy resin, such as a thermoplastic styrenic elastomer (e.g., a polystyrene-polyisoprene-polystyrene block copolymer), preferred examples of the epoxy resin include bisphenol A epoxy resin and bisphenol F epoxy resin, which both are of general-purpose epoxy resin. A bisphenol A diglycidyl ether (DGEBA), which is produced by the reaction of bisphenol A with epichlorohydrin, is typically used. The bisphenol A epoxy resin has benzene rings providing desirable properties such as adhesion, heat resistance, and chemical resistance.

The epoxy resin, such as a bisphenol A-type epoxy resin, can be used in either liquid or solid form determined by its molecular weight. For higher compatibility with a thermoplastic styrenic elastomer, e.g., a polystyrene-polyisoprene-polystyrene block copolymer, a solid epoxy resin having a high molecular weight at room temperature or a liquid to semi-solid epoxy resin having a low molecular weight at room temperature is preferably employed. General-purpose solid epoxy resins in the form of a solid at room temperature typically have a number average molecular weight ranging from 900 to 3,000, preferably have an epoxy equivalent weight ranging from 400 to 2,500 g/eq, more preferably ranging from 450 to 2,200 g/eq. General-purpose liquid epoxy resins in the form of a liquid at room temperature typically have a number average molecular weight ranging from 300 to 500, and preferably have an epoxy equivalent weight ranging from 150 to 400 g/eq, more preferably ranging from 180 to 300 g/eq. The epoxy equivalent (g/eq) refers to the amount of a resin in grams having one gram-equivalent of an epoxy group. The liquid epoxy resin preferably has a viscosity ranging from 5,000 to 30,000 mPa's at 25° C., more preferably ranging from 10,000 to 20,000 mPa·s at 25° C.

As the curing agent, any compound having an active group capable of reacting with an epoxy group to cure the epoxy resin is employed. Examples of the curing agent include dicyandiamide; polyaminoamide; 4,4′-diaminodiphenyl sulfone; imidazole-based compounds, e.g., 2-n-heptadecylimidazole; organic acid hydrazide compounds such as adipic acid dihydrazide, stearic acid dihydrazide, isophthalic acid dihydrazide, and dicarboxylic acid hydrazide; urea-based compounds such as N,N-dialkylurea derivatives and N,N-dialkylthiourea derivatives; acid anhydride, e.g., tetrahydrophthalic anhydride; semicarbazide; cyanoacetamide; diaminodiphenylmethane; amine-based compounds such as aliphatic or aromatic tertiary amine, polyamine, isophorone diamine, and m-phenylenediamine; aminotriazole, e.g., 3-amino-1,2,4-triazole; N-aminoethylpiperazine; melamine; guanamine such as acetoguanamine and benzoguanamine; guanidine; dimethylurea; boron trifluoride compounds; boron trichloride compounds; Lewis acid complex compounds; polymercaptan, liquid phenolic compounds such as tris(dimethylaminomethyl) phenol; polythiol; triphenylphosphine; ketimine compounds; sulfonium salt; onium salt; and phenolic novolac resin. These may be used individually or in combination.

Among these, dispersed latent curing agents, such as dicyandiamide, imidazole compounds, and organic acid hydrazide, which do not react with the epoxy resin at room temperature but are activated by heat, are preferably employed for ease of preparation. For higher adhesive strength and storage stability allowing dispersion in the epoxy resin in a finely powdered state, dicyandiamide (including derivatives such as polyepoxide addition, amide-modified, mannich-modified, and michael addition compounds), which is activated by heat, is more preferably employed. Such dicyandiamides, which allow the curing agent components to dissolve and be activated by heat, are capable of curing the epoxy resin at a temperature of 160-180° C.

The content of the curing agent such as amines, e.g., dicyandiamide, is determined by referring to the amine equivalent and the epoxy equivalent. For example, the content of the curing agent such as dicyandiamide is set in the range of 1 to 20 parts by weight, preferably 2 to 15 parts by weight, more preferably 5 to 10 parts by weight, per 100 parts by weight of the epoxy resin.

In the implementation of the present disclosure, a curing accelerator may be added to shorten the curing time or lower the curing temperature, thereby accelerating the chemical reaction between the epoxy resin and the curing agent. As the curing accelerator, urea-based compounds such as dimethylurea, imidazole-based compounds, amine-based compounds, and triphenylphosphine can be employed.

If the curing accelerator is added, it is preferably added in an amount of 0.5 to 10 parts by weight, more preferably 0.7 to 8 parts by weight, further preferably 1 to 5 parts by weight, per 100 parts by weight of the epoxy resin. This content allows for accelerating the curing without impairing ease of application, viscosity, and adhesion.

The block copolymer having the hydrocarbon-based rubber-like polymer that is incompatible with the epoxy resin and has a glass transition temperature of 25° C. or lower, and having the polymer that is compatible with the epoxy resin, are either a diblock copolymer or a triblock copolymer, having a polymer block incompatible with the epoxy resin and a polymer block compatible with the epoxy resin. Preferably, the block copolymer is a triblock copolymer having a polymer block compatible with the epoxy resin at the both ends and a polymer block incompatible with the epoxy resin at the middle.

Examples of the block copolymer, having the hydrocarbon-based rubber-like polymer that is incompatible with the epoxy resin and has a glass transition temperature of 25° C. or lower, and having the polymer that is compatible with the epoxy resin, include hydrogenated or non-hydrogenated thermoplastic styrenic elastomer, such as polystyrene-polyisoprene-polystyrene block copolymer (SIS), polystyrene-poly(ethylene-propylene)-polystyrene block copolymer (SEPS), which is a hydrogenated block copolymer of SIS, polystyrene-polybutadiene-polystyrene block copolymer (SBS), and polystyrene-poly(ethylene-butylene)-polystyrene block copolymer (SEBS), which is a hydrogenated block copolymer of SBS, and thermoplastic styrenic elastomer having a polyisobutylene, such as polystyrene-polyisobutylene-polystyrene block copolymer (SIBS). The aforementioned block copolymers are of triblock copolymer having, at both ends, a polymer block that have a glass transition temperature (T_{g}) of more than 25° C. and are compatible with the epoxy resin, and, at the middle, a rubbery hydrocarbon-based block that has a glass transition temperature (T_{g}) of 25° C. or lower and is incompatible with the epoxy resin.

The polystyrene-polyisoprene-polystyrene block copolymer (SIS) is a type of thermoplastic styrenic elastomer (TPS), which belongs to the category of thermoplastic elastomer (TPE). It is a triblock copolymer having styrene(S) and isoprene (I), which are incompatible with each other. This thermoplastic block copolymer has polystyrene blocks, which function as hard segments and have a glass transition temperature (T_{g}) of approximately 100° C., and an isoprene block, which functions as a soft segment and has a glass transition temperature (T_{g}) of approximately −20° C. to −80° C., which together form a basic structural unit of the block copolymer.

The polystyrene-polyisoprene-polystyrene block copolymer (SIS) manufactured by known methods, such as solution polymerization (batch process), may be used. For example, products such as Quintac (registered trademark) available from Nippon Zeon Corporation, VECTOR (registered trademark) available from TSRC Corporation, Hybrar available from Kuraray Co., Ltd., and Kraton D available from Kraton Polymers Japan Co., Ltd. may be used. The polystyrene-polyisoprene-polystyrene block copolymer (SIS) is typically produced by the following method. First, a purified solvent, such as hexane or cyclohexane, is charged into a polymerization vessel, followed by adding purified styrene. Next, a lithium catalyst, such as butyllithium, is added as a polymerization initiator. Thus, the styrene is polymerized under a nitrogen atmosphere to produce polystyrene lithium. Isoprene is then added to the resultant reaction mixture to produce polystyrene-polyisoprene lithium, and additional styrene is added to produce polystyrene-polyisoprene-polystyrene lithium. After the polymerization is complete, the active lithium end groups are terminated by treatment with water, acid, or alcohol. It is in this way that the polystyrene-polyisoprene-polystyrene block copolymer (SIS) can be obtained. Such a production method employing the living anionic polymerization allows the control of the content, molecular weight, and molecular weight distribution of the styrene and the isoprene, as well as the monomer sequence including the sequence and branching structure of the styrene and the isoprene, and the isomeric composition of the polyisoprene segment, and allows for more freedom of polymer structural design. The polystyrene-polyisoprene-polystyrene block copolymer (SIS) typically has symmetric both ends in which the polystyrene blocks are the same in molecular weight. Alternatively, it may have unsymmetric both ends in which each polystyrene block is different in molecular weight.

The polystyrene-polybutadiene-polystyrene block copolymer (SBS) is also a type of thermoplastic styrenic elastomer (TPS), which belongs to the category of thermoplastic elastomer (TPE). It is a triblock copolymer having styrene(S) and butadiene (B), which are incompatible with each other. This thermoplastic block copolymer has the polystyrene blocks, which function as hard segments and have a glass transition temperature (T_{g}) of approximately 100° C., and a butadiene block, which functions as a soft segment and has a glass transition temperature (T_{g}) of approximately −20° C. to −80° C., which together form a basic structural unit of the block copolymer. Similar to the polystyrene-polyisoprene-polystyrene block copolymer (SIS), the polystyrene-polybutadiene-polystyrene block copolymer (SBS) was manufactured by the aforementioned process, in which the butadiene is employed in place of the isoprene, may be used. For example, products such as TUFPRENE (registered trademark) and ASAPRENE (registered trademark) available from Asahi Kasei Chemical Corporation, and Epofriend available from Daicel Corporation may be used.

The polystyrene-poly(ethylene-propylene)-polystyrene block copolymer (SEPS), which is a saturated or hydrogenated TPS formed through the hydrogenation of the polyisoprene soft segment in the polystyrene-polyisoprene-polystyrene block copolymer (SIS or unsaturated TPS), may be used. Further, the polystyrene-poly(ethylene-butylene)-polystyrene block copolymer (SEBS), which is a saturated (hydrogenated) TPS formed through the hydrogenation of the polybutadiene soft segment in the polystyrene-polybutadiene-polystyrene block copolymer (SBS or unsaturated TPS), may be used. As the polystyrene-poly(ethylene-propylene)-polystyrene block copolymer (SEPS), Septon available from Kuraray Corporation and TAIPOL (registered trademark) available from TSRC Corporation may be used. As the polystyrene-poly(ethylene-butylene)-polystyrene block copolymer (SEBS), Tuftec (registered trademark) available from Asahi Kasei Chemical Corporation, Rubaron (registered trademark) available from Mitsubishi Chemical Group, ACTYMER available from Riken Technos Co., Ltd., Elastomer AR available from Aronkasei Co., Ltd., and Kraton G available from Kraton Polymer Japan Corporation may be used.

The polystyrene-polyisobutylene-polystyrene block copolymer (SIBS) is a type of isobutylene-based thermoplastic elastomer, which belongs to the category of thermoplastic elastomers (TPE). It is a triblock copolymer having styrene(S) and isobutylene (IB). This thermoplastic block copolymer has polystyrene blocks, which function as hard segments and have a glass transition temperature (T_{g}) of approximately 100° C., and a polyisobutylene block, which functions as a soft segment and has a glass transition temperature (T_{g}) of approximately −80° C., which together form a basic structural unit of the block copolymer.

The polystyrene-polyisobutylene-polystyrene block copolymer (SIBS) manufactured by living cationic polymerization may be used. For example, products such as SIBSTAR (registered trademark) available from Kaneka Corporation may be used.

Such a block copolymer having the hydrocarbon-based rubber-like polymer that is incompatible with the epoxy resin and has a glass transition temperature of 25° C. or lower, and having the polymer that is compatible with the epoxy resin, are contained in the epoxy adhesive composition. Since the polymer compatible with the epoxy resin is compatible with the epoxy resin, the hydrocarbon-based rubber-like polymer incompatible with the epoxy resin can be dispersed within a matrix of the epoxy resin. As a result, this hydrocarbon-based rubber-like polymer imparts stretchability, flexibility, and elasticity to the epoxy resin, thereby enhancing its toughness. This means that the cured epoxy resin exhibits improved peel strength and impact resistance. The toughening, provided by the block copolymer having the hydrocarbon-based rubber-like polymer that is incompatible with the epoxy resin and has a glass transition temperature of 25° C. or lower, and having the polymer that is compatible with the epoxy resin, helps to relieve internal stress caused by curing shrinkage or heat shrinkage during the curing of the adhesive composition, as well as interfacial stress resulting from the difference in the coefficient of thermal expansion between the adhesive and adherend. Consequently, the durability of the cured adhesive including the cured epoxy resin can be improved.

Preferably, the polymer compatible with the epoxy resin is present in the block copolymer at 3 to 80 mass %. This content allows the polymer to be highly compatible with the epoxy resin and be more homogeneously blended with the epoxy resin, thereby yielding the cured adhesive with more stable properties. More preferably, the polymer compatible with the epoxy resin is present in the block copolymer at 5 to 70 mass %, further preferably 10 to 50 mass %. For reference, commercially available TPS products manufactured by chemical manufacturers generally contain 10 to 50 wt % polystyrene. Thus, the block copolymer having the above-described content of the polymer is easily available, allowing the obtained cured adhesive to have more stable properties.

Preferably, the hydrocarbon-based rubber-like polymer is present in the block copolymer at 20 to 97 mass %. This content of the hydrocarbon-based rubber-like polymer allows for an increase in stretchability, flexibility, and elasticity, thereby enhancing peel strength and impact resistance. More preferably, the hydrocarbon-based rubber-like polymer is present in the block copolymer at 30 to 95 mass %, further preferably 50 to 90 mass %.

The content of the block copolymer is preferably set in the range of 0.1 to 4000 parts per 100 parts by weight of the epoxy resin. This content allows for the effective toughening of the cured epoxy resin while maintaining ease of application. More preferably, the content of the block copolymer is set in the range of 0.5 to 3500 parts by weight, still more preferably 0.8 to 3400 parts by weight, most preferably 2.0 to 3200 parts by weight, per 100 parts by weight of the epoxy resin.

The hydrocarbon-based rubber-like polymer in the block copolymer is preferably present at 0.5 to 3000 parts by weight, per 100 parts by weight of the epoxy resin. This content allows for an increase in stretchability, flexibility, and elasticity, thereby enhancing peel strength and impact resistance. More preferably, the hydrocarbon-based rubber-like polymer in the block copolymer is preferably present at 0.7 to 2800 parts by weight, still more preferably 2.0 to 2600 parts by weight, most preferably 3.0 to 2500 parts by weight, per 100 parts by weight of the epoxy resin.

The polymer compatible with the epoxy resin in the block copolymer is preferably present at 0.1 to 650 parts by weight, per 100 parts by weight of the epoxy resin. This content allows the polymer to be highly compatible with the epoxy resin and be more homogeneously blended with the epoxy resin, thereby yielding the cured adhesive with more stable properties. More preferably, the polymer compatible with the epoxy resin in the block copolymer is present at 0.15 to 620 parts by weight, still more preferably 0.2 to 600 parts by weight, per 100 parts by weight of the epoxy resin.

It is preferable that the hydrocarbon-based rubber-like polymer in the block copolymer should have the monomer unit of isoprene, butadiene, hydrogenated isoprene, or hydrogenated butadiene. The content of this monomer unit is preferably 50 mol % or more, more preferably 70 mol % or more, and still more preferably 90 mol % or more.

It is preferable that the polymer compatible with the epoxy resin should have the monomer unit of a styrene moiety, a methacrylic moiety, an acrylic moiety, or an ether moiety. The content of this monomer unit is preferably 50 mol % or more, more preferably 70 mol % or more, and still more preferably 90 mol % or more.

This formulation enables improvement in properties such as rubber elasticity, heat aging resistance, and weather resistance.

More preferably, the block copolymer is a thermoplastic styrenic elastomer (TPS). As described above, examples of the thermoplastic styrenic elastomer include polystyrene-polyisoprene-polystyrene block copolymer (SIS), polystyrene-poly(ethylene-propylene)-polystyrene block copolymer (SEPS), which is a hydrogenated block copolymer of SIS, polystyrene-polybutadiene-polystyrene block copolymer (SBS), and polystyrene-poly(ethylene-butylene)-polystyrene block copolymer (SEBS), which is a hydrogenated block copolymer of SBS. These thermoplastic styrenic elastomers (TPS) are available at low cost and have high elasticity, enabling enhancement of peel strength and impact resistance of the cured epoxy resin in a cost-effective manner.

In the present embodiment, the method of producing the epoxy adhesive composition include, but are not limited to, a mixing step and a solvent removal step. In the mixing step, the epoxy resin and the block copolymer are mixed with the solvent. In the solvent removal step, the resultant mixture is heated to evaporate the solvent. By performing these steps, the masterbatch of the epoxy adhesive composition can be prepared. The curing agent may be mixed together with the epoxy resin, the block copolymer, and the solvent in the mixing step, or it may be added after the solvent removal step. Furthermore, depending on the type of adherend, other additives may be added to the masterbatch of the epoxy adhesive composition to provide the adhesive composition with desired properties.

As a mixer for mixing or kneading the epoxy resin and the block copolymer with the solvent, planetary mixer, disperser (dissolver), henschel mixer, kneader, roll mill, homogenizer, intermixer, roller, and the like can be used. Mixing or kneading the epoxy resin and the block copolymer with the solvent allows the components to be dispersed, providing a homogeneous mixture.

Examples of the solvent include tetrahydrofuran (THF) 2-methyltetrahydrofuran, toluene, acetone, cyclohexane, n-hexane, ethyl acetate, methanol, dichloromethane (methylene chloride), methyl ethyl ketone (MEK), butyl acetate, methylcyclohexane (MCH), N,N-dimethylformamide (DMF), and N-methyl-2-pyrrolidone (NMP).

The epoxy adhesive composition prepared in this manner of the present embodiment is in the form of a liquid, paste, film, or sheet. The liquid or paste epoxy adhesive composition can be applied to an adherend (substrate of interest) by known methods such as spraying or applying with a gun using a pump, or brushing. If the epoxy adhesive composition is applied to a vehicle body, the liquid or paste adhesive composition is applied to the joints of the vehicle body by spraying or using a gun with a pump during the assembly process. The film or sheet epoxy adhesive composition can be formed on an adherend by applying the solution containing the resin, the block copolymer, and the solvent onto the adherend, followed by removing the applied solution. Alternatively, the film or sheet epoxy adhesive composition can also be attached to an adherend.

The liquid or paste epoxy adhesive composition can be obtained when the content of the block copolymer is in the range of 0.5 to 60 parts by weight per 100 parts by weight of the epoxy resin.

For example, the liquid or paste epoxy adhesive composition can be prepared by mixing the block copolymer and the epoxy resin with the solvent to form a liquid or paste mixture, followed by removing the solvent through evaporation. In the liquid or paste epoxy adhesive composition, the content of the block copolymer is preferably in the range of 2.0 to 56 parts by weight, more preferably 4.0 to 55 parts by weight, per 100 parts by weight of the epoxy resin.

The film or sheet epoxy adhesive composition can be obtained when the content of the block copolymer is more than 60 parts by weight and up to 3000 parts by weight, per 100 parts by weight of the epoxy resin.

For example, the film or sheet epoxy adhesive composition can be prepared by mixing the block copolymer and the epoxy resin with the solvent to form a liquid mixture, followed by spreading the liquid mixture onto a substrate such as a sheet-covered board or a sheet-covered vat, and then by removing the solvent through evaporation. In the film or sheet epoxy adhesive composition, the content of the block copolymer is preferably in the range of 80 to 3000 parts by weight, more preferably 100 to 2500 parts by weight, per 100 parts by weight of the epoxy resin.

In implementing the aspects of the disclosure, if necessary, depending on the type of adherend (i.e., object to be bonded), adhesion sites, or desired properties, one or more additives may be added. Examples of the additive include reactive diluent for reducing viscosity or improving flowability, such as epoxy-type reactive diluent with an epoxy group, filler such as heavy calcium carbonate or talc, powdery silica, carbon black such as Ketjenblack, colloidal calcium carbonate (fine calcium carbonate), sepiolite, thixotropic agent such as colloidal hydrous aluminum silicate-organic composite, viscosity modifier, thickener,
heat-resistant agent such as multifunctional epoxy resin, e.g., novolac epoxy resin, glycidyl amine resin, or glycidyl ether resin, acrylic resin for improving adhesion, or coupling agent. Additionally, other additives may be added. Examples of the other additive include pigment, dye, colorant, defoamer, leveling agent, adhesive agent (bonding agent), flame retardant, catalyst, plasticizer, reaction retardant, anti-aging agent, antioxidant, antistatic agent, conductive agent, lubricant, sliding agent, UV absorber, surfactant, dispersant, dispersion stabilizer, dehydrating agent, cross-linking agent, rust inhibitor, and solvent.

The epoxy adhesive composition of the present embodiment contains the epoxy resin, the curing agent, and the block copolymer having the polymer that is compatible with the epoxy resin and having the hydrocarbon-based rubber-like polymer that is incompatible with the epoxy resin and has a glass transition temperature of 25° C. or lower. This block copolymer having the hydrocarbon-based rubber-like polymer and the polymer that is compatible with the epoxy resin enables improvement in the toughness of the epoxy resin, which is inherently brittle, poor in flexibility, and lacks toughness. Thus, the cured adhesive produced from the epoxy adhesive composition has toughened cured adhesive.

This is considered to be because the polymer being compatible with the epoxy resin is chemically bonded to the hydrocarbon-based rubber-like polymer being incompatible with the epoxy resin in the block copolymer. As a result, the hydrocarbon-based rubber-like polymer is dispersed even at room temperature, thereby exerting its stretchability, flexibility, and elasticity.

Thus, the block copolymer imparts toughness. This results in reducing stress caused by curing shrinkage during curing and by thermal shrinkage during cooling from curing temperature to room temperature. Further, it reduces stress caused by the difference in thermal expansion coefficients between the cured adhesive layer and adherend. For dissimilar material bonding, higher stress may be generated due to a large difference in thermal expansion coefficients between the materials. However, such stress also can be effectively reduced. Consequently, the peel strength of the cured adhesive is improved. Since the hydrocarbon-based rubber-like polymer exerts its stretchability, flexibility, and elasticity, the cured adhesive exhibits higher impact strength and can absorb more impact energy.

Thus, the block copolymer helps to relieve stress and impact energy, thereby providing the improved durability of the cured adhesive.

The epoxy resin is a thermoset resin, whereas the block copolymer having the polymer that is compatible with the epoxy resin and having the hydrocarbon-based rubber-like polymer that is incompatible with the epoxy resin and has a glass transition temperature of 25° C. or lower, is a thermoplastic elastomer. Although the epoxy resin and the block copolymer differ in thermal properties, the block copolymer is homogeneously blended with the epoxy resin without exhibiting phase separation. This is because the polymer having compatibility with the epoxy resin in the block copolymer is compatible with the epoxy resin. As described above, mixing the epoxy resin and the block copolymer with a predetermined solvent facilitates homogeneous blending of the block copolymer with the epoxy resin.

Regarding the toughening of the epoxy resin, a conventional method involves imparting flexibility by incorporating a rubber-like structure or a linear polymer structure into the main chain, side chain, or terminal group of the epoxy resin. However, this method impairs ease of application due to increased viscosity of the epoxy resin, and deteriorates the inherent properties of the epoxy resin, such as heat resistance and adhesion, due to decrease in crosslink density.

For the modification of the epoxy resin, a liquid rubber, such as an acrylonitrile-butadiene copolymer, has been used as a flexibility-imparting agent. However, such liquid rubber is poor in compatibility and difficult to blend with the epoxy resin, requiring significant time and effort for mixing process. Additionally, the liquid rubber is incompatible with the cured epoxy resin and thus exhibits poor dispersibility, resulting in a limited toughening effect. During curing, the liquid rubber undergoes phase separation, forming large domains (dispersed rubber particle phase) of several to several tens of micrometers or larger. The formation of these domains strongly depends on curing conditions, leading to unstable properties. To achieve effective modification and stable quality, precision and effort are required to control the micro-phase separation structure by adjusting the amount of the liquid rubber and the curing conditions. Furthermore, a portion of un-crosslinked rubber remains dissolved in the cured epoxy resin, causing decrease in the glass transition temperature (T_{g}) and elasticity of the epoxy resin. This may lead to change in the inherent properties of the epoxy resin.

To address these issues with the liquid rubber, the use of core-shell rubber particles has also been proposed. However, it is difficult to achieve uniform dispersion of the powdered core-shell rubber particles in thermosetting resins without breaking their structure. Further, the presence of the shell reduces the proportion of the rubber component, thereby diminishing toughening effect per unit amount added. Thus, there is a limit to toughening effect by improving flexibility and stretchability without impairing ease of application. Furthermore, the core-shell rubber particles require significant time, effort, and cost to manufacture.

In contrast, the epoxy adhesive composition of the present embodiment allows the block copolymer, having the polymer that is compatible with the epoxy resin and having the hydrocarbon-based rubber-like polymer that is incompatible with the epoxy resin and has a glass transition temperature of 25° C. or lower, to provide toughness. As will be described in detail later, since the polymer having compatibility with the epoxy resin in the block copolymer is compatible with the epoxy resin, phase-separated domains are not formed even at room temperature. As a result, the hydrocarbon-based rubber-like polymer provides stretchability, flexibility, and elasticity, allowing for increase in toughness with increasing its content. This means that the cured epoxy resin adhesive exhibits improved peel strength and impact strength. That is, in the block copolymer having the polymer that is compatible with the epoxy resin and having the hydrocarbon-based rubber-like polymer that is incompatible with the epoxy resin and has a glass transition temperature of 25° C. or lower, the polymer having compatibility with the epoxy resin in the block copolymer is compatible with the epoxy resin and thus the hydrocarbon-based rubber-like polymer is well dispersed in a matrix of the epoxy resin. As a result, the hydrocarbon-based rubber-like polymer significantly exerts stretchability, flexibility, and elasticity, thereby imparting toughness leading to improved peel strength and impact strength. Furthermore, the block copolymer, having the polymer that is compatible with the epoxy resin and having the hydrocarbon-based rubber-like polymer that is incompatible with the epoxy resin and has a glass transition temperature of 25° C. or lower, is easy to synthesize and readily available at low cost.

Thus, the block copolymer, having the polymer that is compatible with the epoxy resin and having the hydrocarbon-based rubber-like polymer that is incompatible with the epoxy resin and has a glass transition temperature of 25° C. or lower, imparts stretchability, flexibility, and elasticity, thereby providing toughness. This enables reduction in internal stress caused during the curing process and cooling process, as well as internal stress at the interface caused by differences in thermal expansion coefficients between the adhesive layer and adherend, thereby imparting resistance to crack propagation and suppressing crack initiation.

Further, the block copolymer, having the polymer that is compatible with the epoxy resin and having the hydrocarbon-based rubber-like polymer that is incompatible with the epoxy resin and has a glass transition temperature of 25° C. or lower, enables improvement in toughness while maintaining easy application and preserving the inherent properties of the epoxy resin, such as heat resistance, high adhesion, mechanical properties, and durability. Furthermore, it enables stress reduction by mitigating residual strain caused by curing and thermal shrinkage, allowing for enhancement of crack resistance, fatigue resistance, and durability.

In the block copolymer, having the polymer that is compatible with the epoxy resin and having and the hydrocarbon-based rubber-like polymer that is incompatible with the epoxy resin and has a glass transition temperature of 25° C. or lower, the hydrocarbon-based rubber-like polymer and the polymer being compatible with the epoxy resin are mutually incompatible. It is easy to produce the block copolymer with varying ratios of the hydrocarbon-based rubber-like polymer to the polymer being compatible with the epoxy resin. Adjusting ratios of the hydrocarbon-based rubber-like polymer to the epoxy resin-compatible polymer allows the properties of the cured adhesive to be easily controlled. Furthermore, the increased flexibility, stretchability, and elasticity may contribute to enhancing vibration damping.

Examples of the block-copolymer-containing epoxy-based adhesive composition according to the embodiment of the present disclosure will be now described.

### Example 1

In Example 1, an adhesive composition (hereinafter also referred to simply as “adhesive”) in a film or sheet form containing Quintac (registered trademark) 3440, a bisphenol A-type epoxy resin, and a dicyandiamide was prepared. Quintac (registered trademark) 3440 is a polystyrene-polyisoprene-polystyrene block copolymer composition (hereinafter also referred to simply as “SIS¹⁹”) available from Zeon Corporation. As the bisphenol A-type epoxy resin (hereinafter also referred to simply as “EP resin”), a bisphenol A diglycidyl ether (DGEBA), which is a bifunctional epoxy resin, was employed. It is a general-purpose epoxy resin and liquid at room temperature. The dicyandiamide (hereinafter also referred to simply as “DICY”) functions a latent curing agent. The SIS¹⁹ contains 19 wt % polystyrene. The polystyrene block (hereinafter also referred to simply as “S block”) in the SIS¹⁹ is a polymer compatible with the EP resin. The polyisoprene block (hereinafter also referred to simply as “I block”) in the SIS¹⁹ is a hydrocarbon-based rubber-like polymer that has a glass transition temperature of approximately −60° C. and is incompatible with the EP resin or insoluble in the EP resin.

In Example 1, the SIS¹⁹, 13.3 g, the EP resin, 6.67 g, and the DICY, 0.467 g, were weighed out and dissolved in 133 g of a mixed solvent of THF and methanol (weight ratio 8:2). The resultant solution was transferred to a vat covered with a Teflon (registered trademark) sheet (20×16.5 cm) and subjected to solvent casting at 35° C. for one day. The resultant mixture was vacuum-dried at room temperature for at least two days to evaporate the volatile solvent (THF and methanol), giving a mixture used as the adhesive composition. The resulting mixture was a one-component thermosetting epoxy adhesive composition in the form of a relatively homogeneous film or sheet. In Example 1, the adhesive composition contained 200 parts by weight of the SIS¹⁹ (having 162 parts by weight of the I block) and 7 parts by weight of the DICY, relative to 100 parts by weight of the EP resin.

### Example 2

In Example 2, a mixture film composed of the SIS¹⁹, the EP resin, and the DICY was prepared as in Example 1, except that the content of the SIS¹⁹ (having 324 parts by weight of the I block) was 400 parts by weight relative to 100 parts by weight of the EP resin. This film was used as the adhesive.

### Example 3

In Example 3, a mixture film composed of the SIS¹⁹, the EP resin, and the DICY was prepared as in Example 1, except that the content of the SIS¹⁹ (having 486 parts by weight of the I block) was 600 parts by weight relative to 100 parts by weight of the EP resin. This film was used as the adhesive.

### Example 4

In Example 4, an amine adduct accelerator, AJICURE TMMY-24 (hereinafter also referred to simply as “AA”) was added as an additive. A mixture film composed of the SIS¹⁹, the EP resin, the DICY, and the AA was prepared as in Example 1, except that 1 part by weight of the AA was added relative to 100 parts by weight of the EP resin. This film was used as the adhesive. The AA was mixed with the SIS¹⁹, the EP resin, the DICY, and the solvent during the mixing process. The same procedure was applied in the following examples.

### Example 5

In Example 5, a mixture film composed of the SIS¹⁹, the EP resin, the DICY, and the AA was prepared as in Example 1, except that the content of the SIS¹⁹ (having 243 parts by weight of the I block) was 300 parts by weight and 1 part by weight of the AA was added, relative to 100 parts by weight of the EP resin. This film was used as the adhesive.

### Example 6

In Example 6, a mixture film composed of the SIS¹⁹, the EP resin, the DICY, and the AA was prepared as in Example 1, except that the content of the SIS¹⁹ (having 486 parts by weight of the I block) was 600 parts by weight and 1 part by weight of the AA was added, relative to 100 parts by weight of the EP resin. This film was used as the adhesive.

### Example 7

In Example 7, a mixture film composed of the SIS¹⁹, the EP resin, the DICY and the AA was prepared as in Example 1, except that the content of the SIS¹⁹ (having 810 parts by weight of the I block) was 1000 parts by weight and 1 part by weight of the AA was added, relative to 100 parts by weight of the EP resin. This film was used as the adhesive.

### Example 8

In Example 8, a mixture film composed of the SIS¹⁹, the EP resin, the DICY, and the AA was prepared as in Example 1, except that the content of the SIS¹⁹ (having 1539 parts by weight of the I block) was 1900 parts by weight and 1 part by weight of the AA was added, relative to 100 parts by weight of the EP resin. This film was used as the adhesive.

### Example 9

In Example 9, a mixture film composed of the SIS¹⁹, the EP resin, the DICY, and the AA was prepared as in Example 1, except that the content of the SIS¹⁹ (having 2430 parts by weight of the I block) was 3000 parts by weight and 1 part by weight of the AA was added, relative to 100 parts by weight of the EP resin. This film was used as the adhesive.

### Example 10

In Example 10, a relatively homogeneous liquid mixture containing 100 parts by weight of the EP resin and 23 parts by weight of the SIS¹⁹ (having 18.6 parts by weight of the I block) was firstly prepared. The 7 parts by weight of the DICY and 1 part by weight of the AA, per 100 parts by weight of the EP resin were then added to the liquid mixture and thoroughly stirred, to give a liquid mixture. This liquid mixture was used as the adhesive.

In Example 10, 100 g of the SIS¹⁹ and 500 g of a THF were placed in a round-bottom flask and thoroughly stirred at room temperature using a mechanical stirrer. Subsequently, 500 g of the EP resin was added and thoroughly stirred at room temperature using a mechanical stirrer. The resultant mixed solution was subjected to rotary evaporation to remove the THF. The resultant mixture was then vacuum-dried at 55° C. for 18 hours while stirring with a mechanical stirrer to evaporate almost all of the THF. The resulting mixture composed of the SIS¹⁹ and the EP resin was a relatively homogeneous liquid.

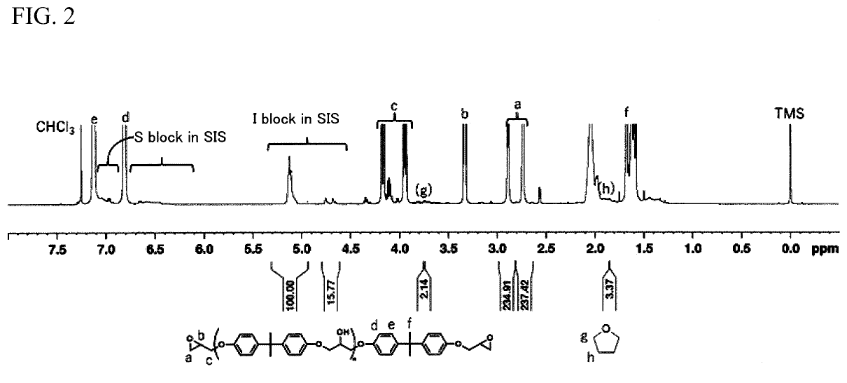

The composition of the obtained liquid mixture was determined by proton nuclear magnetic resonance spectroscopy (¹H-NMR). For the NMR measurement, a deuterated chloroform was used as the solvent. The obtained ¹H-NMR spectrum is shown in FIG. 2. The molar ratio of components was determined from the integral values of the signal derived from the protons of the I block in the SIS¹⁹, the signal (a) derived from the protons of the epoxy ring in the EP resin, and the signal (b) derived from the protons of the THF. Estimation of weight ratio based on the molar ratio relieved that the liquid mixture contained 23 parts by weight of the SIS¹⁹ and 0.12 parts by weight of the THF, per 100 parts by weight of the EP resin, indicating that the THF had been substantially removed.

Further, 7 parts by weight of the DICY and 1 part by weight of the AA, relative to 100 parts by weight of the EP resin, were mixed with the obtained liquid mixture, to give a mixture used as the adhesive composition. The resulting mixture was a one-component thermosetting epoxy adhesive composition in the form of a relatively homogeneous liquid.

### Example 11

In Example 11, as with Example 10, a relatively homogeneous paste mixture was prepared by mixing 100 parts by weight of the EP resin with 56 parts by weight of the SIS¹⁹ (having 45.4 parts by weight of the I block). Subsequently, 7 parts by weight of the DICY and 1 part by weight of the AA were added, to give a paste mixture used as the adhesive. To determine the amount of the THF remaining in the obtained paste mixture, the obtained paste mixture was subjected to ¹H-NMR measurement in the same manner as in Example 10. As a result, it was found that the obtained paste mixture contained 1.7 parts by weight of the THF per 100 parts by weight of the EP resin, indicating that the THF had been substantially removed.

### Example 12

In Example 12, as with Example 10, a relatively homogeneous liquid mixture was prepared by mixing 100 parts by weight of the EP resin with 12 parts by weight of the SIS¹⁹ (having 9.7 parts by weight of the I block). Subsequently, 7 parts by weight of the DICY and 1 part by weight of the AA were added, to give a liquid mixture used as the adhesive. To determine the amount of the THF remaining in the obtained liquid mixture, the obtained liquid mixture was subjected to ¹H-NMR measurement in the same manner as in Example 10. As a result, it was found that the obtained liquid mixture contained 0.15 parts by weight of the THF per 100 parts by weight of the EP resin, indicating that the THF had been substantially removed.

### Example 13

In Example 13, as with Example 10, a relatively homogeneous liquid mixture was prepared by mixing 100 parts by weight of the EP resin with 5.6 parts by weight of the SIS¹⁹ (having 4.5 parts by weight of the I block). Subsequently, 7 parts by weight of the DICY and 1 part by weight of the AA were added, to give a liquid mixture used as the adhesive. To determine the amount of the THF remaining in the obtained liquid mixture, the obtained liquid mixture was subjected to ¹H-NMR measurement in the same manner as in Example 10. As a result, it was found that the obtained liquid mixture contained 0.50 parts by weight of the THF per 100 parts by weight of the EP resin, indicating that the THF had been substantially removed.

### Example 14

In Example 14, as with Example 10, a relatively homogeneous liquid mixture was prepared by mixing 100 parts by weight of the EP resin with 0.87 parts by weight of the SIS¹⁹ (having 0.71 parts by weight of the I block). Subsequently, 7 parts by weight of the DICY and 1 part by weight of the AA were added, to give a liquid mixture used as the adhesive. To determine the amount of the THF remaining in the obtained liquid mixture, the obtained liquid mixture was subjected to ¹H-NMR measurement in the same manner as in Example 10. As a result, it was found that the obtained liquid mixture contained 0.69 parts by weight of the THF per 100 parts by weight of the EP resin, indicating that the THF had been substantially removed.

### Example 15

In Example 15, Quintac (registered trademark) 3290 (hereinafter also referred to simply as “SIS³⁵”), which is a polystyrene-polyisoprene-polystyrene block copolymer composition available from Zeon Corporation, was used in place of the SIS¹⁹. The content of the SIS³⁵ was 200 parts by weight relative to 100 parts by weight of the EP resin. A mixture film composed of the SIS³⁵, the EP resin, and the DICY was prepared as in Example 1, except that the SIS³⁵ was used. This mixture film was used as the adhesive. Quintac (registered trademark) 3290 contains 35 wt % polystyrene. The S block in the SIS³⁵ is a polymer that is compatible with the EP resin. The I block in the SIS³⁵ is a hydrocarbon-based rubber-like polymer that has a glass transition temperature of approximately −60° C. and is incompatible with (or insoluble in) the EP resin. In Example 15, the content of the I block was 130 parts by weight relative to 100 parts by weight of the EP resin in the mixture film.

### Example 16

In Example 16, a mixture film composed of the SIS³⁵, the EP resin, and the DICY was prepared as in Example 1, except that the content of the SIS³⁵ (having 65 parts by weight of the I block) was 100 parts by weight relative to 100 parts by weight of the EP resin. This mixture film was used as the adhesive.

### Example 17

In Example 17, Quintac (registered trademark) 3390 (hereinafter also referred to simply as “SIS⁴⁸”), which is a polystyrene-polyisoprene-polystyrene block copolymer composition available from Zeon Corporation, was used in place of the SIS¹⁹. The content of the SIS⁴⁸ was 100 parts by weight relative to 100 parts by weight of the EP resin. A mixture film composed of the SIS⁴⁸, the EP resin, and the DICY was prepared as in Example 1, except that the SIS¹⁹ was used. This mixture film was used as the adhesive. Quintac (registered trademark) 3390 contains 48 wt % polystyrene. The S block in the SIS⁴⁸ is a polymer that is compatible with the EP resin. The I block in the SIS⁴⁸ is a hydrocarbon-based rubber-like polymer that has a glass transition temperature of approximately −60° C. and is incompatible with (or insoluble in) the EP resin. In Example 17, the content of the I block was 52 parts by weight relative to 100 parts by weight of the EP resin in the mixture film.

### Example 18

In Example 18, a mixture film composed of the SIS⁴⁸, the EP resin, and the DICY was prepared as in Example 1, except that the content of the SIS⁴⁸ (having 39 parts by weight of the I block) was 75 parts by weight relative to 100 parts by weight of the EP resin. This mixture film was used as the adhesive.

### Example 19

In Example 19, a polystyrene-polybutadiene-polystyrene block copolymer (hereinafter also referred to simply as “SBS”) was used in place of the SIS¹⁹. The polystyrene-polybutadiene-polystyrene block copolymer was a composition containing 30 wt % polystyrene, which was purchased from Aldrich (Product No. 432490). The content of the SBS was 200 parts by weight relative to 100 parts by weight of the EP resin. Further, the AA was added. A mixture film composed of the SBS, the EP resin, the DICY, and the AA was prepared as in Example 1, except that the SBS was used and the AA was added. This mixture film was used as the adhesive. The S block in the SBS is a polymer that is compatible with (or soluble in) the EP resin. The polybutadiene block (hereinafter also referred to simply as “B block”) in the SBS is a hydrocarbon-based rubber-like polymer that has a glass transition temperature of approximately −60° C. and is incompatible with the EP resin. In Example 20, the content of the SBS (having 140 parts by weight of the B block) was 200 parts by weight, the content of the DICY was 7 parts by weight, and the content of the AA was 1 part by weight, relative to 100 parts by weight of the EP resin.

### Example 20

In Example 20, a mixture film composed of the SBS, the EP resin, the DICY, and the AA was prepared as in Example 19, except that the content of the SBS (having 280 parts by weight of the B block) was 400 parts by weight relative to 100 parts by weight of the EP resin. This mixture film was used as the adhesive.

### Example 21

In Example 21, as with Example 10, a relatively homogeneous liquid mixture was prepared by mixing 100 parts by weight of the EP resin with 18.5 parts by weight of the SBS (having 13 parts by weight of the B block). Subsequently, 7 parts by weight of the DICY and 1 part by weight of the AA were added, to give a liquid mixture used as the adhesive. To determine the amount of the THF remaining in the obtained liquid mixture, the obtained liquid mixture was subjected to ¹H-NMR measurement in the same manner as in Example 10. As a result, it was found that the obtained liquid mixture contained 0.25 parts by weight of the THF per 100 parts by weight of the EP resin, indicating that the THF had been substantially removed.

### Example 22

In Example 22, as with Example 10, a relatively homogeneous liquid mixture was prepared by mixing 100 parts by weight of the EP resin with 5.6 parts by weight of a polystyrene-poly(ethylene-ran-butylene)-polystyrene block copolymer (hereinafter also referred to simply as “SEBS”) that is a composition containing 29 wt % polystyrene, which was purchased from Aldrich (Product No. 200557). Subsequently, 7 parts by weight of the DICY and 1 part by weight of the AA were added, to give a liquid mixture used as the adhesive. The poly(ethylene-ran-butylene) block (hereinafter referred to as “EB block”) in the SEBS copolymer is a hydrocarbon-based rubber-like polymer that has a glass transition temperature of 25° C. or lower and is incompatible with (or insoluble in) the EP resin. The content of the EB block was 4.0 parts by weight. To determine the amount of the THF remaining in the obtained liquid mixture, the obtained liquid mixture was subjected to ¹H-NMR measurement in the same manner as in Example 10. As a result, it was found that the obtained liquid mixture contained 0.30 parts by weight of the THF per 100 parts by weight of the EP resin, indicating that the THF had been substantially removed.

### Example 23

In Example 23, a polystyrene-poly(ethylene-alt-propylene)-polystyrene block copolymer (hereinafter also referred to simply as “SEPS”), which is a composition containing 17.5 wt % polystyrene, was synthesized through hydrogenation of the SIS¹⁹. In the same manner as in Example 10, a relatively homogeneous liquid mixture was prepared by mixing 100 parts by weight of the EP resin with 6.6 parts by weight of the SEPS. Subsequently, 7 parts by weight of the DICY and 1 part by weight of the AA were added, to give a liquid mixture used as the adhesive. The poly(ethylene-alt-propylene) block (hereinafter also referred to simply as “EP block”) in the SEPS copolymer is a hydrocarbon-based rubber-like polymer that has a glass transition temperature of 25° C. or lower and is incompatible with (or insoluble in) the EP resin. The content of the EP block was 5.4 parts by weight.

The SEPS was prepared by the following procedure. First, 10.0 g of the SIS¹⁹ was dissolved in 163 g of p-xylene, followed by adding 101 g of p-toluenesulfonyl hydrazide. The resultant mixture was transferred to a dimroth condenser flask placed in an oil bath and then stirred at 145° C. for 9 hours. The resultant reaction solution was dropped into approximately 3000 ml of methanol to deposit polymer. The deposited polymer was separated from methanol through suction filtration, and the resulting polymer was vacuum-dried sufficiently and then dissolved in THF. The resultant solution was again dropped into methanol to deposit the polymer. This purification procedure was repeated three times to remove impurities such as unreacted p-toluenesulfonyl hydrazide, byproducts, and solvents. The SEPS was thus obtained.

The obtained SEPS was dissolved in deuterated chloroform to prepare an approximately 2 wt % solution. The resulting solution was subjected to ¹H-NMR measurement. As a result, it was found that the peak appearing at 4.5 to 5.3 ppm, derived from the protons attached to the C═C double bond, was significantly reduced and 99.6% of the C═C double bond had been changed into the C—C single bond, determined from the integral values of the peak appearing at 6.2 to 7.2 ppm derived from the phenyl groups of the polystyrene.

As with Example 10, a relatively homogeneous liquid mixture was prepared by mixing 100 parts by weight of the EP resin with 6.6 parts by weight of the SEPS (having 5.4 parts by weight of the EP block). Subsequently, 7 parts by weight of the DICY and 1 part by weight of the AA were added, to give a liquid mixture used as the adhesive. To determine the amount of the THF remaining in the obtained liquid mixture, the obtained liquid mixture was subjected to ¹H-NMR measurement in the same manner as in Example 10. As a result, it was found that the obtained liquid mixture contained 0.59 parts by weight of the THF per 100 parts by weight of the EP resin, indicating the THF had been substantially removed.

### Example 24

In Example 24, 5 parts by weight of silica particles, REOLOSIL (registered trademark) QS-40 available from Tokuyama Corporation (the same silica particles were used in following examples), were added per 100 parts by weight of the EP resin. Except for the addition of the silica particles, a mixture film composed of the SIS¹⁹, the EP resin, the DICY, and the silica particles was prepared in the same manner as in Example 1. This mixture film was used as the adhesive. The silica particles were mixed with the SIS¹⁹, the EP resin, the DICY, and the solvent during the mixing process. The same procedure was applied in the following examples.

### Example 25

In Example 25, a mixture film composed of the SIS¹⁹, the EP resin, the DICY, the AA, and the silica particles was prepared as in Example 1, except that 1 part by weight of the AA and 5 parts by weight of the silica particles were added per 100 parts by weight of the EP resin. This mixture film was used as the adhesive.

### Example 26

In Example 26, a mixture film composed of the SIS¹⁹, the EP resin, the DICY, and the silica particles was prepared as in Example 1, except that the content of the SIS¹⁹ (having 486 parts by weight of the I block) was 600 parts by weight and 5 parts by weight of the silica particles was added, per 100 parts by weight of the EP resin. This mixture film was used as the adhesive.

### Example 27

In Example 27, 5 parts by weight of colloidal calcium carbonate particles, VISCOEXCEL (registered trademark) 30 HV available from Shiraishi Kogyo Kaisha, Ltd., (the same colloidal calcium carbonate particles were used in following examples) were added per 100 parts by weight of the EP resin. Except for the addition of the colloidal calcium carbonate particles, a mixture film composed of the SIS¹⁹, the EP resin, the DICY, and the colloidal calcium carbonate particles was prepared in the same manner as in Example 1. This mixture film was used as the adhesive. The colloidal calcium carbonate particles were mixed with the SIS¹⁹, the EP resin, the DICY, and the solvent during the mixing process. The same procedure was applied in the following examples.

### Example 28

In Example 28, a mixture film composed of the SIS¹⁹, the EP resin, the DICY, and the colloidal calcium carbonate particles was prepared as in Example 1, except that the content of the SIS¹⁹ (having 486 parts by weight of the I block) was 600 parts by weight and 5 parts by weight of the colloidal calcium carbonate particles were added, per 100 parts by weight of the EP resin. This mixture film was used as the adhesive.

An adhesive composition with no block copolymer was also prepared as a comparative example.

### Comparative Example 1

In Comparative Example 1, no polymer other than the EP resin was compounded. A liquid mixture was prepared by mixing 100 parts by weight of the EP resin with 7 parts by weight of the DICY and 1 part by weight of the AA. This liquid mixture was used as the adhesive.

The cured adhesive produced from the epoxy adhesive composition according to the examples and the comparative example was subjected to tensile lap-shear test, T-peel test, and dumbbell tensile test.

### [Tensile Lap Shear Test]

Each film adhesive composition of Examples 1-9, 15-20, and 24-28 was cut into pieces of approximately 25 mm×12.5 mm. The cut film piece (providing the adhesive area of approximately 25 mm×12.5 mm) was put between two SPC270 steel substrates with a thickness of 1.6 mm, a width of 25 mm, and a length of 100 mm, together with glass beads (having a diameter of approximately 0.2 mm) used as spacers, followed by fixing them with a clip. The assembled sample was heated in an oven at 170° C. for 50 minutes, to give a test piece in which the substrates bonded with a thermally cured mixture film (thermally cured film adhesive). The obtained test piece was subjected to tensile lap-shear test. The tensile lap-shear test was performed using AGS-X testing machine (Shimadzu Corporation) with a 10 kN load cell and pneumatic flat grips, under the conditions of room temperature, an air pressure of 0.40 MPa applied to the grips, and a tensile speed of 50 mm/min. The average value obtained from three times tests for each sample is shown in Table 1 below.

Each liquid or paste adhesive composition of Examples 10-14, 21-23, and Comparative Example 1 was applied between two SPC270 steel substrates with a thickness of 1.6 mm, a width of 25 mm, and a length of 100 mm (such that the adhesive area was approximately 25 mm×12.5 mm), together with glass beads (having a diameter of approximately 0.2 mm) used as spacers, followed by fixing them with a clip. Same as above, the assembled sample was heated in an oven at 170° C. for 50 minutes, to give a test piece in which the substrates were bonded with a thermally cured adhesive. The obtained test piece was subjected to the tensile lap-shear test. Same as above, the tensile lap-shear test was performed using AGS-X testing machine (Shimadzu Corporation) with a 10 kN load cell and pneumatic flat grips, under the conditions of room temperature, an air pressure of 0.40 MPa applied to the grips, and a tensile speed of 50 mm/min. The average value obtained from twice tests for each sample is shown in Table 1 below.

### [T-Peel Test]

T-peel test in accordance with JIS K 6854-3 (1999) for determining T-peel strength was performed.

Each film adhesive composition of Examples 1-9, 15-20, and 24-28 was cut into pieces of approximately 25 mm×150 mm. The cut film piece was put between two SPC270 steel substrates (used as adherends) for T-peel test, each having a thickness of 0.8 mm, a width of 25 mm, and a length of 150 mm, together with glass beads (having a diameter of approximately 0.2 mm) used as spacers, followed by fixing them with a clip. The assembled sample was heated in an oven at 170° C. for 50 minutes, to give a test piece in which the substrates were bonded with a thermally cured mixture film (thermally cured film adhesive). The obtained test piece was subjected to the T-peel test. The T-peel test was performed using AGS-X testing machine (Shimadzu Corporation) with a 500 N load cell and pneumatic flat grips, under the conditions of room temperature, an air pressure of 0.40 MPa applied to the grips, and a tensile speed of 200 mm/min. The average value obtained from three times tests for each sample is shown in Table 1 below.

Each liquid or paste adhesive composition of Examples 10-14, 21-23, and Comparative Example 1 was applied between two SPC270 steel substrates (used as adherends) for T-peel test, each having a thickness of 0.8 mm, a width of 25 mm, and a length of 150 mm, together with glass beads (having a diameter of approximately 0.2 mm) used as spacers, followed by fixing them with a clip. Same as above, the assembled sample was heated in an oven at 170° C. for 50 minutes, to give a test piece in which the substrates were bonded with a thermally cured adhesive. The obtained test piece was subjected to the T-peel test. Similarly to the above, the T-peel test was performed using AGS-X testing machine (Shimadzu Corporation) with a 500 N load cell and screw flat grips, under the conditions of room temperature and a tensile speed of 50 mm/min. The average value obtained from twice tests for each sample is shown in Table 1 below.

### [Dumbbell Tensile Test]

Each film adhesive composition of Examples 1-9, 15-20, and 24-28 was heated in an oven at 170° C. for 50 minutes, to give a thermally cured film specimen. The obtained film specimen with a thickness of 0.5 mm was punched using a punching blade conforming dumbbell-shaped Type 6 or 7 specimen in accordance with Japanese Industrial Standards, JIS K6251: 2017, to give a test piece. The obtained test piece was subjected to dumbbell tensile test. The tensile test was performed using AGS-X testing machine (Shimadzu Corporation) with a 500 N load cell and pneumatic flat grips. For the dumbbell-shaped Type 6 specimen, the test was performed at room temperature with an air pressure of 0.40 MPa applied to the grips, a grasp separation of approximately 50 mm, and an initial strain rate of approximately 0.033/s (a tensile speed of 100 mm/min). For the dumbbell-shaped type 7 specimen, the test was performed at room temperature with an air pressure of 0.40 MPa applied to the grips, a grasp separation of approximately 10 mm, and an initial strain rate of approximately 0.017/s (a tensile speed of 10 mm/min). The average value obtained from twice tests for each sample is shown in Table 1 below. The Young's modulus was determined from the initial gradient (which is a slope in 0-10% strain range) of the stress-strain diagram. The tensile strength was determined from the maximum value of the stress. The elongation at break is defined as the ratio of the amount of elongation to the original length when the test piece is stretched to break.

Each liquid adhesive composition of Example 10 and Comparative Example 1 was defoamed at 60° C. for 30 minutes under vacuum and then transferred to a Teflon (register trademark) mold corresponding to dumbbell-shaped Type 6 or 7 specimen in accordance with Japanese Industrial Standards, JIS K6251: 2017. The resultant specimen was then heated in an oven at 170° C. for 50 minutes, to give a thermally cured test piece with a thickness of approximately 2 mm. The tensile test was performed on the test piece, using AGS-X testing machine (Shimadzu Corporation) with a 10 kN load cell and pneumatic flat grips, under the conditions of room temperature, an air pressure of 0.40 MPa applied to the grips, a grip separation of approximately 50 mm, and initial strain rate of approximately 0.017/s (a tensile speed of 50 mm/min). The average value obtained from twice tests for each sample is shown in Table 1 below. The Young's modulus was determined from the initial gradient (which is a slope in 0-0.3% strain range) of the stress-strain diagram. The tensile strength was determined from the maximum value of the stress. The elongation at break is defined as the ratio of the amount of elongation to the original length when the test piece is stretched to break.

The formulations and the test results in the examples and comparative examples are shown in Table 1 below.

TABLE 1

| | | | content of | | | | | |
|---|---|---|---|---|---|---|---|---|
| | | | rubber-like | | content | | | |
| | | content | polymer in | content | of latent | content of | | |
| | | of block | block | of epoxy | curing | curing | | content of |
| | type of | copolymer | copolymer | resin | agent | accelerator | | additive |
| | block | (part by | (part by | (part by | (part by | (part by | type of | (part by |
| | copolymer | weight) | weight) | weight) | weight) | weight) | additive | weight) |
| Example 1 | SIS¹⁹ | 200 | 162 | 100 | 7 | — | — | — |
| Example 2 | SIS¹⁹ | 400 | 324 | 100 | 7 | — | — | — |
| Example 3 | SIS¹⁹ | 600 | 486 | 100 | 7 | — | — | — |
| Example 4 | SIS¹⁹ | 200 | 162 | 100 | 7 | 1 | — | — |
| Example 5 | SIS¹⁹ | 300 | 243 | 100 | 7 | 1 | — | — |
| Example 6 | SIS¹⁹ | 600 | 486 | 100 | 7 | 1 | — | — |
| Example 7 | SIS¹⁹ | 1000 | 810 | 100 | 7 | 1 | — | — |
| Example 8 | SIS¹⁹ | 1900 | 1539 | 100 | 7 | 1 | — | — |
| Example 9 | SIS¹⁹ | 3000 | 2430 | 100 | 7 | 1 | — | — |
| Example 10 | SIS¹⁹ | 23 | 18.6 | 100 | 7 | 1 | — | — |
| Example 11 | SIS¹⁹ | 56 | 45.4 | 100 | 7 | 1 | — | — |
| Example 12 | SIS¹⁹ | 12 | 9.7 | 100 | 7 | 1 | — | — |
| Example 13 | SIS¹⁹ | 5.6 | 4.5 | 100 | 7 | 1 | — | — |
| Example 14 | SIS¹⁹ | 0.87 | 0.71 | 100 | 7 | 1 | — | — |
| Example 15 | SIS³⁵ | 200 | 130 | 100 | 7 | — | — | — |
| Example 16 | SIS³⁵ | 100 | 65 | 100 | 7 | — | — | — |
| Example 17 | SIS⁴⁸ | 100 | 52 | 100 | 7 | — | — | — |
| Example 18 | SIS⁴⁸ | 75 | 39 | 100 | 7 | — | — | — |
| Example 19 | SBS | 200 | 140 | 100 | 7 | 1 | — | — |
| Example 20 | SBS | 400 | 280 | 100 | 7 | 1 | — | — |
| Example 21 | SBS | 18.5 | 13 | 100 | 7 | 1 | — | — |
| Example 22 | SEBS | 5.6 | 4.0 | 100 | 7 | 1 | — | — |
| Example 23 | SEPS | 6.6 | 5.4 | 100 | 7 | 1 | — | — |
| Example 24 | SIS¹⁹ | 200 | 162 | 100 | 7 | — | silica | 5 |
| Example 25 | SIS¹⁹ | 200 | 162 | 100 | 7 | 1 | silica | 5 |
| Example 26 | SIS¹⁹ | 600 | 486 | 100 | 7 | — | silica | 5 |
| Example 27 | SIS¹⁹ | 200 | 162 | 100 | 7 | — | colloidal | 5 |
| | | | | | | | calcium | |
| | | | | | | | carbonate | |
| Example 28 | SIS¹⁹ | 600 | 486 | 100 | 7 | — | colloidal | 5 |
| | | | | | | | calcium | |
| | | | | | | | carbonate | |
| Comparative | — | — | — | 100 | 7 | 1 | — | — |
| Example 1 | | | | | | | | |

| | | tensile | | | | |
|---|---|---|---|---|---|---|
| | | lap shear | | | | |
| | | test | T-peel | | | |
| | form | tensile | test | dumbbell tensile properties | | |
| | before | lap shear | peel | Young's | tensile | elongation |
| | thermal | strength | strength | modulus | strength | at break |
| | curing | (Mpa) | (N/25 mm) | (Mpa) | (Mpa) | (%) |
| Example 1 | film | 1.8 | 45.1 | 9.3 | 2.2 | 280 |
| Example 2 | film | 1.7 | 46.9 | 2.9 | 1.3 | 400 |
| Example 3 | film | 1.5 | 52.1 | 2.5 | 2.1 | 780 |
| Example 4 | film | 2.6 | 43 | 5.4 | 1.7 | 255 |
| Example 5 | film | 0.79 | 79.7 | 4.9 | 3.4 | 780 |
| Example 6 | film | 1.8 | 70.2 | 3.8 | 4.8 | 1560 |
| Example 7 | film | 1.9 | 69.7 | 4.4 | 8.8 | 2310 |
| Example 8 | film | 2.2 | 35.2 | 2.9 | 7.0 | 2460 |
| Example 9 | film | 1.6 | 55.2 | 3.4 | 12.0 | 2830 |
| Example 10 | liquid | 15.5 | 110 | 1650 | 9.5 | 0.61 |
| Example 11 | paste | 3.3 | 143 | — | — | — |
| Example 12 | liquid | 18.6 | 76.2 | — | — | — |
| Example 13 | liquid | 17.8 | 37.9 | — | — | — |
| Example 14 | liquid | 18.6 | 10.3 | — | — | — |
| Example 15 | film | 3.1 | 27.9 | 0.9 | 0.8 | 83.3 |
| Example 16 | film | 3.3 | 19.9 | 30.3 | 1.5 | 33.1 |
| Example 17 | film | 3.8 | 12.6 | 19 | 1.7 | 24 |
| Example 18 | film | 4 | 12.1 | 28.1 | 1.7 | 15 |
| Example 19 | film | 3.0 | 70.0 | 54.1 | 1.7 | 65 |
| Example 20 | film | 2.3 | 43.2 | 43.0 | 1.6 | 230 |
| Example 21 | liquid | 18.5 | 44.5 | — | — | — |
| Example 22 | liquid | 18.4 | 22.5 | — | — | — |
| Example 23 | liquid | 16.4 | 43.8 | — | — | — |
| Example 24 | film | 1.1 | 63 | 2 | 0.4 | 74 |
| Example 25 | film | 1.3 | 61 | 6.1 | 0.6 | 134 |
| Example 26 | film | 1.2 | 49 | 1.8 | 0.6 | 200 |
| Example 27 | film | 2.1 | 104 | 12.9 | 1.5 | 134 |
| Example 28 | film | 2.2 | 120 | 5.4 | 4.7 | 950 |
| Comparative | liquid | 16.5 | 26.7 | 2410 | 12.0 | 0.61 |
| Example 1 | | | | | | |

As shown in Table 1, the adhesive of Comparative Example 1, which was formed from the composition containing the EP resin, the DICY (used as a latent curing agent), the AA (used as an amine adduct curing accelerator), and no block copolymer, exhibited a tensile lap shear strength of 16.5 Mpa in the lap shear test, a peel strength of 26.7 N/25 mm in the T-peel test, a Young's modulus of 2410 Mpa in the dumbbell tensile test, a tensile strength of 12.0 Mpa in the dumbbell tensile test, and an elongation at break of 0.61% in the dumbbell tensile test. The Young's modulus was determined from the initial gradient (which is a slope in 0-0.3% strain range) of the stress-strain diagram.

In contrast, the film adhesives of Examples 1-9 and 24-28, which contained the SIS¹⁹, all exhibited high peel strength. This is considered to be because the I block provides stretchability, flexibility, and elasticity and thus toughens the cured epoxy resin, as indicated by the significantly high elongation at break in the dumbbell tensile test. Specifically, the S block in SIS is compatible with the EP resin while the I block, which is the rubber-like polymer in the SIS, is incompatible with the EP resin. Accordingly, the S block compatible with the EP resin allows the I block to be dispersed in a matrix of the EP resin. The I block dispersed in a matrix of the EP resin exerts its rubber-like characteristics and imparts stretchability, flexibility, and elasticity, thereby toughening the cured epoxy resin, even after thermal curing.

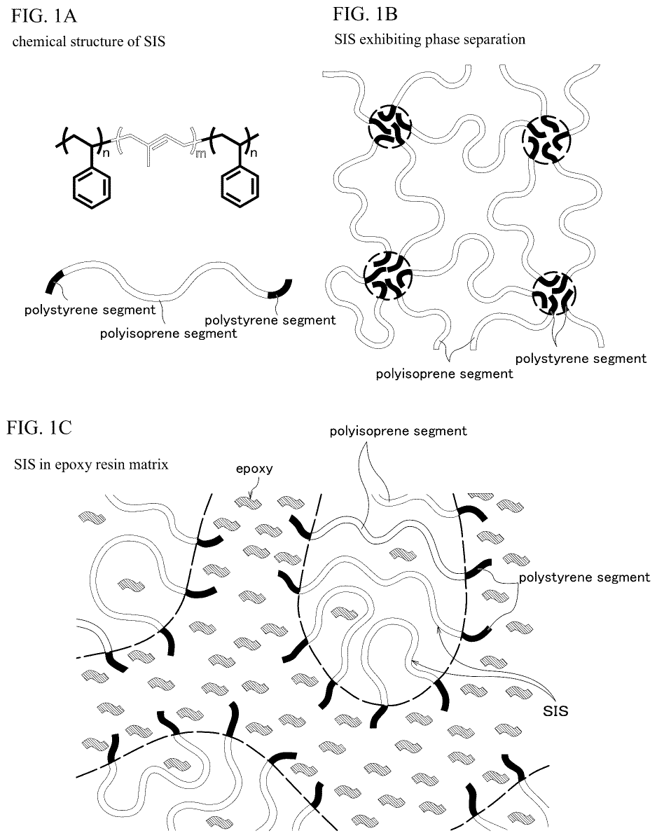

As illustrated in FIG. 1B, in the polystyrene-polyisoprene-polystyrene block copolymer, in which the chain-connected polyisoprene block is polymerized with the polystyrene at its both ends, the polystyrene block (hard segment) is thermodynamically incompatible with the polyisoprene block (soft segment) at room temperature. The polystyrene segments aggregate and form polystyrene domains. Accordingly, the polystyrene-polyisoprene-polystyrene block copolymer exhibits micro-phase separation structure. Specifically, the polystyrene segment has a glass transition temperature (T_{g}) that is higher than room temperature and thus exists in a glassy state at room temperature. Such hard polystyrene segments aggregate and form the polystyrene domains, thereby creating pseudo-cross-linking points that physically cross-link the polyisoprene segment.

In contrast, ss illustrated in FIG. 1C, in the cured adhesive produced from the epoxy adhesive composition containing the epoxy resin, the curing agent, and the polystyrene-polyisoprene-polystyrene block copolymer, the polystyrene segment in the polystyrene-polyisoprene-polystyrene block copolymer is compatible with the epoxy resin at room temperature and thus does not aggregate and form any pseudo-crosslinking point. The polyisoprene segment, therefore, is dispersed in the epoxy resin matrix. Such a polyisoprene segment is considered to act as rubber and thus provides stretchability, flexibility, and elasticity. As a result, the cured epoxy resin has improved toughness and exhibits high peel strength.

This observation is supported by comparison among the examples. As can be seen from comparison among Examples 1-3, as the isoprene content relative to the epoxy resin increases, the peel strength increases. This result indicates that the polyisoprene segment provides flexibility, stretchability, and elasticity. Furthermore, as can be seen from comparison between the film adhesives of Examples 1-9, which contained the SIS¹⁹, and the film adhesives of Examples 15-18, which contained the SIS³⁵ or the SIS⁴⁸, the film adhesives of Examples 1-9 with a higher content of the polyisoprene exhibited higher peel strength than those of Examples 15-18, although the film adhesives of Examples 15-18 exhibited higher elongation at break in the dumbbell tensile test than that of Comparative Example 1.

The adhesive of Comparative Example 1 exhibited cohesive failure (CF) in the tensile lap shear test and the T-peel test, whereas the adhesive of Example 1 frequently exhibited adhesive failure (AF) or thin layer cohesive failure (TCF) as a result of improved toughness.

The adhesives of Examples 1-9 and 15-18 exhibited lower lap shear strength than that of Comparative Example 1. This is because the adhesives of these examples have a lower epoxy resin content than that of Comparative Example 1.

In the adhesives of Examples 24-28, which contained either the silica or the colloidal calcium carbonate, or both, it was observed that either the peel strength or the lap shear strength, or both, tended to be higher. This result indicates that the addition of the silica or the colloidal calcium carbonate improves the mechanical strength of the adhesive.

It was observed that the adhesives produced from the composition in the form of a paste or film containing the SIS¹⁹ in Examples 10-14 exhibited either higher peel strength or higher lap shear strength, or both, than that in Comparative Example 1.

It was observed that the adhesives containing the SBS in Examples 19-21 exhibited in one or more of improved elongation at break in the dumbbell tensile test, tension strength, peel strength, and lap shear strength. In the adhesives containing the SBS in these examples, the S block in the SBS is compatible with the EP resin, while the B block, which is the rubber-like polymer in the SBS, is incompatible with the EP resin. Since the S block is compatible with the EP resin, the B block is dispersed in the EP resin matrix. It is believed that the B block dispersed in the EP resin matrix acts as rubber and provides stretchability, flexibility, and elasticity, thereby toughening the epoxy resin, even after thermal curing of the EP resin.

Likewise, it was observed that the adhesive containing the SEBS in Examples 22 and the adhesive containing the SEPS in Examples 23 exhibited either improved peel strength or improved lap shear strength, or both. In the adhesive containing the SEBS of the example, the S block in the SEBS is compatible with the EP resin, while the EB block, which is the rubber-like polymer in the SEBS, is incompatible with the EP resin. Since the S block in the SEBS is compatible with the EP resin, the EB block is dispersed in the EP resin matrix. It is believed that the EB block dispersed in the EP resin matrix acts as rubber and provides stretchability, flexibility, and elasticity, thereby toughening the epoxy resin, even after thermal curing of the EP resin. In the adhesive containing the SEPS of the example, the S block in SEPS is compatible with the EP resin, while the EP block, which is the rubber-like polymer in the SEPS, is incompatible with the EP resin. Since the S block in the SEPS is compatible with the EP resin, the EP block is dispersed in the EP resin matrix. It is believed that the EP block dispersed in the EP resin matrix acts as rubber and provides stretchability, flexibility, and elasticity, thereby toughening the epoxy resin, even after thermal curing of the EP resin.

As described above, the tensile strength or the elongation at break in the dumbbell tensile test increases with an increasing content of the hydrocarbon-based rubber-like polymer, such as the polyisoprene block (I block), the polybutadiene block (B block), the poly(ethylene-ran-butylene) block (EB block), and the poly(ethylene-alt-propylene) block (EP block), in the block copolymer, that is, with a decreasing content of the polystyrene block (S block), which is the polymer compatible with the epoxy resin.

Additionally, the present inventors performed impact resistance test on Examples 1-3 and 15-18, and Comparative Example 1.

### [Impact Resistance Test]

Impact resistance test was performed in accordance with the determination of dynamic resistance to cleavage under impact conditions (Wedge impact method) in accordance with JIS K6865.

Each film adhesive composition of Examples 1-3 and 15-18 was cut into pieces of approximately 25 mm×150 mm. The cut film piece (providing the adhesive area of approximately 25 mm×150 mm) was put between two steel plate cold commercials (used as adherends composed of SPC270 steel substrates for determination of dynamic resistance to cleavage), each having a thickness of 0.8 mm, a width of 25 mm, and a length of 150 mm, together with glass beads (having a diameter of approximately 0.2 mm) used as spacers, followed by fixing them with a clip. The assembled sample was heated in an oven at 170° C. for 60 minutes, to give a symmetric wedge test piece in which the substrates were bonded with a thermally cured film adhesive. The obtained test piece was subjected to impact resistance test using a high-speed tensile machine (Shimadzu Corporation). In the impact resistance test, a quenched steel wedge for the test was used to apply a cleavage load to the symmetric wedge test piece at room temperature (approximately 20° C.), with a test speed of 2 m/s. Testing force or strength (KN) was determined from displacement (stroke) ranging from 25 to 90% and its average strength (KN) was divided by the width (mm) of the test piece to calculate impact strength.

The liquid adhesive of Comparative Example 1 was applied between two steel plate cold commercials (used as adhesives composed of SPC270 steel substrates for determination of dynamic resistance to cleavage), each having a thickness of 0.8 mm, a width of 25 mm, and a length of 150 mm, together with glass beads (having a diameter of approximately 0.2 mm) used as spacers, followed by fixing them with a clip. Thereafter, a test piece was prepared in the same manner as described above, and subjected to the impact resistance test.

The results of the impact resistance test are shown in Table 2 below. The test resulting shown in Table 2 represents the average value obtained from twice tests for each sample.

TABLE 2

| | | | content of | | | | | |
|---|---|---|---|---|---|---|---|---|
| | | | rubber-like | | content of | | | impact |
| | | content | polymer in | content of | latent | content of | | resistance |
| | | of block | block | epoxy | curing | curing | form | test |
| | type of | copolymer | copolymer | resin | agent | accelerator | before | impact |
| | block | (parts by | (parts by | (parts by | (parts by | (parts by | thermal | strength |
| | copolymer | weight) | weight) | weight) | weight) | weight) | curing | (KN/m) |
| Example 1 | SIS¹⁹ | 200 | 162 | 100 | 7 | — | film | 11.4 |
| Example 2 | SIS¹⁹ | 400 | 324 | 100 | 7 | — | film | 11.5 |
| Example 3 | SIS¹⁹ | 600 | 486 | 100 | 7 | — | film | 11.8 |
| Example 15 | SIS³⁵ | 200 | 130 | 100 | 7 | — | film | 11.4 |
| Example 16 | SIS³⁵ | 100 | 65 | 100 | 7 | — | film | 11.4 |
| Example 17 | SIS⁴⁸ | 100 | 52 | 100 | 7 | — | film | 7.5 |
| Example 18 | SIS⁴⁸ | 75 | 39 | 100 | 7 | — | film | 5.7 |
| Comparative | — | — | — | 100 | 7 | 1 | liquid | 1.6 |
| Exmaple 1 | | | | | | | | |

As shown in Table 2, the adhesive of Comparative Example 1, which was formed from the composition containing the EP resin (epoxy resin), the DICY (latent curing agent), and the AA (amine adduct curing accelerator), and no block copolymer, exhibited an impact strength of 1.6 KN/m. In contrast, the adhesive of Examples 1-3, and 15-18, which contained the SIS, exhibited an impact strength of 5.7 KN/m or greater, showing improved impact resistance. As described above, this is considered to be because the I block provides stretchability, flexibility, and elasticity and thus toughens the cured epoxy resin, as indicated by a higher elongation at break in the dumbbell tensile test of the examples than that of Comparative Example 1. Specifically, the S block in SIS is compatible with the EP resin, while the I block, which is the rubber-like polymer in the SIS, is incompatible with the EP resin. Accordingly, the S block compatible with the EP resin allows the I block to be dispersed in a matrix of the EP resin. The I block dispersed in a matrix of the EP resin exerts its rubber-like characteristics and exhibits stretchability, flexibility, and elasticity, thereby toughening the cured epoxy resin, even after thermal curing.

Furthermore, the present inventors performed the T-peel test and the impact resistance test on the adhesives produced from the compositions of examples and comparative example, each having the formulation shown in Table 3 below.

TABLE 3

| | | | content of | | | | | | | |
|---|---|---|---|---|---|---|---|---|---|---|
| | | | rubber-like | | | | | | | |
| | | content of | polymer in | | content of | content of | | | impact | |
| | | block | block | content of | latent curing | curing | | content of | resistance | T-peel test |
| | type of | copolymer | copolymer | epoxy resin | agent | accelerator | | additive | impact | peel |
| | block | (parts by | (parts by | (parts by | (parts by | (parts by | type of | (parts by | strength | strength |
| | copolymer | weight) | weight) | weight) | weight) | weight) | additive | weight) | (KN/m) | (N/25 mm) |
| Example 29 | SIS¹⁹ | 10 | 8 | 100 | 6 | 1 | colloidal | 38 | 2.2 | 43.9 |
| | | | | | | | calcium | | | |
| | | | | | | | carbonate | | | |
| | | | | | | | calcium oxide | 2 | | |
| Example 30 | SIS¹⁹ | 15 | 12 | 100 | 6 | 1 | colloidal | 39 | 5.1 | 50 |
| | | | | | | | calcium | | | |
| | | | | | | | carbonate | | | |
| | | | | | | | calcium oxide | 2 | | |
| Example 31 | SIS¹⁹ | 20 | 16 | 100 | 6 | 1 | colloidal | 41 | 5.7 | 57.7 |
| | | | | | | | calcium | | | |
| | | | | | | | carbonate | | | |
| | | | | | | | calcium oxide | 2 | | |
| Example 32 | SIS¹⁹ | 30 | 24 | 100 | 6 | 1 | colloidal | 45 | 7.4 | 57.1 |
| | | | | | | | calcium | | | |
| | | | | | | | carbonate | | | |
| | | | | | | | calcium oxide | 2 | | |
| Example 33 | SIS¹⁹ | 40 | 32 | 100 | 6 | 1 | colloidal | 48 | 9.1 | 68.9 |
| | | | | | | | calcium | | | |
| | | | | | | | carbonate | | | |
| | | | | | | | calcium oxide | 2 | | |
| Example 34 | SIS¹⁹ | 50 | 40 | 100 | 6 | 1 | colloidal | 52 | 10.9 | 78.8 |
| | | | | | | | calcium | | | |
| | | | | | | | carbonate | | | |
| | | | | | | | calcium oxide | 2 | | |
| Example 35 | SIS¹⁹ | 5 | 4 | 100 | 6 | 1 | colloidal | 36 | 1.3 | 45.3 |
| | | | | | | | calcium | | | |
| | | | | | | | carbonate | | | |
| | | | | | | | calcium oxide | 2 | | |
| Comparative | — | 0 | 0 | 100 | 6 | 1 | colloidal | 34 | 1.1 | 48.5 |
| Example 2 | | | | | | | calcium | | | |
| | | | | | | | carbonate | | | |
| | | | | | | | calcium oxide | 2 | | |

### Example 29

In Example 29, 6 parts by weight of the DICY, 1 part by weight of a phenyl-1,1-dimethylurea A (hereinafter also referred to simply as “DCMU”) used as a curing accelerator, 38 parts by weight of the colloidal calcium carbonate particles (VISCOEXCEL (registered trademark) 30 HV manufactured by Shiraishi Kogyo Kaisha, Ltd., the same colloidal calcium carbonate particles were used in following examples), and 2 parts by weight of a calcium oxide were added to the liquid mixture that was prepared in the same manner as in Example 10 and contained 10 parts by weight of the SIS¹⁹ and 100 parts by weight of the EP resin. These components were well mixed to yield a liquid mixture containing 10 parts by weight of the SIS¹⁹ (having 8 parts by weight of the I block), 6 parts by weight of the DICY, 1 part by weight of the DCMU, 38 parts by weight of the colloidal calcium carbonate particles, and 2 parts by weight of the calcium oxide, relative to 100 parts by weight of the EP resin. This liquid mixture was used as the adhesive.

### Example 30

In Example 30, 6 parts by weight of the DICY, 1 part by weight of the DCMU, 39 parts by weight of the colloidal calcium carbonate particles, and 2 parts by weight of the calcium oxide were added to the liquid mixture that was prepared in the same manner as in Example 10 and contained 15 parts by weight of the SIS¹⁹ and 100 parts by weight of the EP resin. These components were well mixed to yield a liquid mixture containing 15 parts by weight of the SIS¹⁹ (having 12 parts by weight of the I block), 6 parts by weight of the DICY, 1 part by weight of the DCMU, 39 parts by weight of the colloidal calcium carbonate particles, and 2 parts by weight of the calcium oxide, relative to 100 parts by weight of the EP resin. This liquid mixture was used as the adhesive.

### Example 31

In Example 31, 6 parts by weight of the DICY, 1 part by weight of the DCMU, 41 parts by weight of the colloidal calcium carbonate particles, and 2 parts by weight of the calcium oxide were added to the liquid mixture that was prepared in the same manner as in Example 10 and contained 20 parts by weight of the SIS¹⁹ and 100 parts by weight of the EP resin. These components were well mixed to yield a liquid mixture containing 20 parts by weight of the SIS¹⁹ (having 16 parts by weight of the I block), 6 parts by weight of the DICY, 1 part by weight of the DCMU, 41 parts by weight of the colloidal calcium carbonate particles, and 2 parts by weight of the calcium oxide, relative to 100 parts by weight of the EP resin. This liquid mixture was used as the adhesive.

### Example 32

In Example 32, 6 parts by weight of the DICY, 1 part by weight of the DCMU, 45 parts by weight of the colloidal calcium carbonate particles, and 2 parts by weight of the calcium oxide were added to the liquid mixture that was prepared in the same manner as in Example 10 and contained 30 parts by weight of the SIS¹⁹ and 100 parts by weight of the EP resin. These components were well mixed to yield a liquid mixture containing 30 parts by weight of the SIS¹⁹ (having 24 parts by weight of the I block), 6 parts by weight of the DICY, 1 part by weight of the DCMU, 45 parts by weight of the colloidal calcium carbonate particles, and 2 parts by weight of the calcium oxide, relative to 100 parts by weight of the EP resin. This liquid mixture was used as the adhesive.

### Example 33

In Example 33, 6 parts by weight of the DICY, 1 part by weight of the DCMU, 48 parts by weight of the colloidal calcium carbonate particles, and 2 parts by weight of the calcium oxide were added to the liquid mixture that was prepared in the same manner as in Example 10 and contained 40 parts by weight of the SIS¹⁹ and 100 parts by weight of the EP resin. These components were well mixed to yield a liquid mixture containing 40 parts by weight of the SIS¹⁹ (having 32 parts by weight of the I block), 6 parts by weight of the DICY, 1 part by weight of the DCMU, 48 parts by weight of the colloidal calcium carbonate particles, and 2 parts by weight of the calcium oxide, relative to 100 parts by weight of the EP resin. This liquid mixture was used as the adhesive.

### Example 34

In Example 34, 6 parts by weight of the DICY, 1 part by weight of the DCMU, 52 parts by weight of the colloidal calcium carbonate particles, and 2 parts by weight of the calcium oxide were added to the liquid mixture that was prepared in the same manner as in Example 10 and contained 50 parts by weight of the SIS¹⁹ and 100 parts by weight of the EP resin. These components were well mixed to yield a liquid mixture containing 50 parts by weight of the SIS¹⁹ (having 40 parts by weight of the I block), 6 parts by weight of the DICY, 1 part by weight of the DCMU, 52 parts by weight of the colloidal calcium carbonate particles, and 2 parts by weight of the calcium oxide, relative to 100 parts by weight of the EP resin. This liquid mixture was used as the adhesive.

### Example 35

In Example 35, 6 parts by weight of the DICY, 1 part by weight of the DCMU, 36 parts by weight of the colloidal calcium carbonate particles, and 2 parts by weight of the calcium oxide were added to the liquid mixture that was prepared in the same manner as in Example 10 and contained 5 parts by weight of the SIS¹⁹ and 100 parts by weight of the EP resin. These components were well mixed to yield a liquid mixture containing 5 parts by weight of the SIS¹⁹ (having 4 parts by weight of the I block), 6 parts by weight of the DICY, 1 part by weight of the DCMU, 36 parts by weight of the colloidal calcium carbonate particles, and 2 parts by weight of the calcium oxide, relative to 100 parts by weight of the EP resin. This liquid mixture was used as the adhesive.

### Comparative Example 2

In Comparative Example 2, no polymer other than the EP resin was compounded. A liquid mixture was prepared by mixing 100 parts by weight of the EP resin with 6 parts by weight of the DICY, 1 part by weight of the DCMU, 34 parts by weight of the colloidal calcium carbonate particles, and 2 parts by weight of the calcium oxide. This liquid mixture was used as the adhesive.

The T-peel test and the impact resistance test were performed on Examples 29-35 and Comparative Example 2. The results of these tests are shown in Table 3.

As shown in Table 3, the adhesive of Comparative Example 2, which was formed from the composition containing the EP resin (epoxy resin), the DICY (latent curing agent), the DCMU (urea-based curing accelerator), the colloidal calcium carbonate particles, the calcium oxide, and no block copolymer, exhibited an impact strength of 1.1 KN/m and a peel strength of 48.5 N/25 mm. In contrast, the adhesives of Examples 29-35, which contained the SIS, exhibited an impact strength of 1.3 KN/m or greater, showing improved impact strength. As described above, this is considered to be because the I block provides stretchability, flexibility, and elasticity and thus toughens the epoxy resin. Specifically, the S block in SIS is compatible with the EP resin, while the I block, which is the rubber-like polymer in the SIS, is incompatible with the EP resin. Accordingly, the S block compatible with the EP resin allows the I block to be dispersed in a matrix of the EP resin. The I block dispersed in a matrix of the EP resin acts as rubber and provides stretchability, flexibility, and elasticity, thereby toughening the epoxy resin. In particular, the adhesive of Comparative Example 2 exhibited a peel strength of 48.5 N/25 mm, whereas the adhesives of Examples 30-34, which contained 12 parts by weight of the polyisoprene relative to 100 parts by weight of the EP resin, exhibited a peel strength of 50 N/25 mm or greater, showing excellent peel strength.

Such liquid adhesive compositions in the examples are suitable for structural adhesives for automobiles.

Furthermore, the inventors prepared adhesive compositions of Examples 36-40 and Comparative Example 3, the formulations of which are shown in Table 4 below, and performed the T-peel test, the impact resistance test, the tensile lap-shear test, Fourier transform infrared spectroscopy (FT-IR) measurement, dynamic mechanical analysis (DMA), observation of the nanostructure using a transmission electron microscope (TEM), and differential scanning calorimetry (DSC) on Examples 36-40 and Comparative Example 3.

TABLE 4

| | | | content of | | | | content of | | | tensile | | |
|---|---|---|---|---|---|---|---|---|---|---|---|---|
| | | | rubber- | | | | additive, | | | lap shear | | |
| | | | like | | content | | i.e., | impact | T-peel | strength | T_{g} (° C.) | |
| | | content | polymer | content | of latent | content | colloidal | resistance | test | (Mpa) | | derive |
| | type of | of block | in block | of epoxy | curing | of curing | calcium | test | peel | tensile | derive | from |
| | block | copolymer | copolymer | resin | agent | accelerator | carbonate | impact | strength | lap shear | from | rubber- |
| | copol- | (parts by | (parts by | (part by | (parts by | (parts by | (parts by | strength | (N/25 | strength | epoxy | like |
| | ymer | weight) | weight) | weight) | weight) | weight) | weight) | (KN/m) | mm) | (Mpa) | resin | polymer |
| Example 36 | SIS¹⁹ | 5.6 | 4.5 | 100 | 7 | 1 | 20.0 | 1.8 | 55 | 24 | 148 | — |
| Example 37 | SIS¹⁹ | 9.6 | 7.8 | 100 | 7 | 1 | 20.8 | 4.1 | 60 | 23 | 153 | — |
| Example 38 | SIS¹⁹ | 16 | 13.0 | 100 | 7 | 1 | 21.9 | 5.8 | 59 | 22 | 141 | −55.9 |
| Example 39 | SIS¹⁹ | 19 | 15.4 | 100 | 7 | 1 | 22.4 | 5.5 | 57 | 19 | 149 | −53.1 |
| Example 40 | SIS¹⁹ | 26 | 21.1 | 100 | 7 | 1 | 23.6 | 7.1 | 62 | 17 | 156 | −51.4 |
| Compartive | — | 0 | 0 | 100 | 7 | 1 | 19.1 | 0.62 | 45 | 23 | 148 | — |
| Example 3 | | | | | | | | | | | | |

### Example 36

In Example 36, 7 parts by weight of the DICY, 1 part by weight of the amine adduct accelerator (AA), and 20.0 parts by weight of the colloidal calcium carbonate particles (VISCOEXCEL (registered trademark) 30 HV manufactured by Shiraishi Kogyo Kaisha, Ltd., the same colloidal calcium carbonate particles were used in following examples), were added to the liquid mixture that was prepared in the same manner as in Example 10 and that contained 5.6 parts by weight of the SIS¹⁹ (having 4.5 parts by weight of the I block) and 100 parts by weight of the EP resin, followed by stirring them. The resultant liquid mixture was used as the adhesive.

### Example 37

In Example 37, 7 parts by weight of the DICY, 1 part by weight of the AA, and 20.8 parts by weight of the colloidal calcium carbonate particles were added to the liquid mixture that was prepared in the same manner as in Example 10 and that contained 9.6 parts by weight of the SIS¹⁹ (having 7.8 parts by weight of the I block) and 100 parts by weight of the EP resin, followed by stirring them. The resultant liquid mixture was used as the adhesive.

### Example 38

In Example 38, 7 parts by weight of the DICY, 1 part by weight of the AA, and 21.9 parts by weight of the colloidal calcium carbonate particles were added to the liquid mixture that was prepared in the same manner as in Example 10 and that contained 16 parts by weight of the SIS¹⁹ (having 13.0 parts by weight of the I block) and 100 parts by weight of the EP resin, followed by stirring them. The resultant liquid mixture was used as the adhesive.

### Example 39

In Example 39, 7 parts by weight of the DICY, 1 part by weight of the AA, and 22.4 parts by weight of the colloidal calcium carbonate particles were added to the liquid mixture that was prepared in the same manner as in Example 10 and that contained 19 parts by weight of the SIS¹⁹ (having 15.4 parts by weight of the I block) and 100 parts by weight of the EP resin, followed by stirring them. The resultant liquid mixture was used as the adhesive.

### Example 40

In Example 40, 7 parts by weight of the DICY, 1 part by weight of the AA, and 23.6 parts by weight of the colloidal calcium carbonate particles were added to the liquid mixture that was prepared in the same manner as in Example 10 and that contained 26 parts by weight of the SIS¹⁹ (having 21.1 parts by weight of the I block) and 100 parts by weight of the EP resin, followed by stirring them. The resultant liquid mixture was used as the adhesive.

### Comparative Example 3

In Comparative Example 3, no polymer other than the EP resin was compounded. A liquid mixture was prepared by mixing 100 parts by weight of the EP resin with 7 parts by weight of the DICY, 1 part by weight of the AA, and 19.1 parts by weight of the colloidal calcium carbonate particles and by stirring them. The resultant liquid mixture was used as the adhesive.

The impact resistance test, the T-peel test, and the tensile lap-shear test were performed on Examples 36-40 and Comparative Example 3 in the same manner as described above. The results of these tests are shown in Table 4.

Fourier transform infrared spectroscopy (FT-IR) measurement and dynamic mechanical analysis (DMA) were performed on Example 39, which was one example of the epoxy adhesive composition containing the SIS, and Comparative Example 3, which was one example of the epoxy adhesive composition containing neither the SIS nor any polymer other than the EP resin. Additionally, the nanostructure of the adhesive in Example 39 was observed using a transmission electron microscope (TEM). Differential scanning calorimetry (DSC) was performed on Examples 36-40 and Comparative Example 3.

### [FT-IR Measurement]

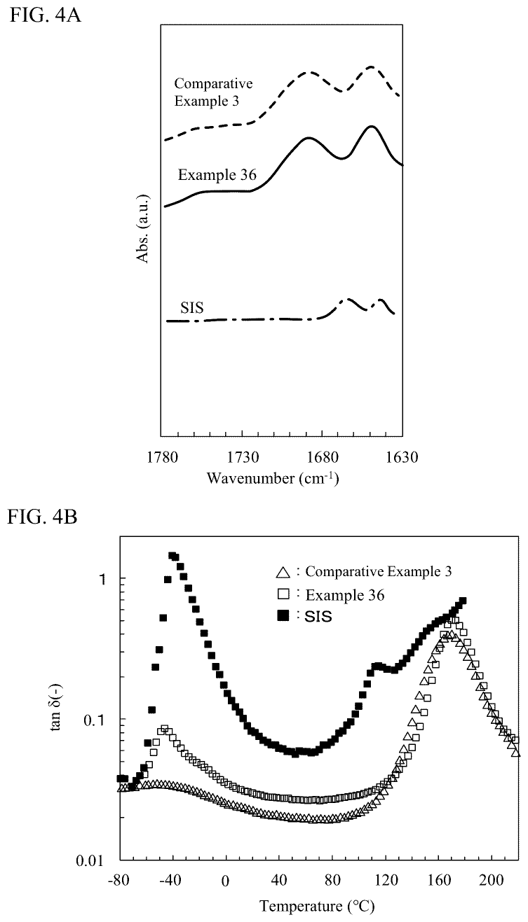

Each liquid adhesive of Example 39 and Comparative Example 3 was applied between potassium bromide (KBr) plates, and then heated in an oven at 170° C. for 50 minutes, to give thermally cured specimen for FT-IR measurement. A control specimen was also prepared by applying the film of the SIS¹⁹ in THF between KBr plates. FT-IR measurement was performed on these specimens at room temperature using FT/IR-6100 (JASCO) under the condition of 1024 scans. The obtained FT-IR spectra of the thermally cured specimens in Example 39 and Comparative Example 3, as well as that of the SIS control specimen, are shown in FIG. 4A.

### [Dynamic Mechanical Analysis]

Each liquid adhesive of Example 39 and Comparative Example 3 was poured into a silicone mold (having dimensions of approximately 4.5 mm (W)×350 mm (L)×2 mm (T)), defoamed at 60° C., and then heated in an oven at 170° C. for 50 minutes, to give a thermally cured test piece. A control test piece was also prepared by solvent casting the film of the SIS¹⁹ using THF. These test pieces were subjected to tensile dynamic mechanical analysis using Rheogel E4000 (UBM) under the conditions of a frequency of 10 Hz, a strain of 0.1%, a jig separation of 20 mm, temperatures ranging from −100 to 300° C., and a heating rate of 10° C./min. The obtained loss tangent (tan 8) data are shown in FIG. 4B. The specimen of Example 39 containing the SIS showed a relatively strong peak near −50° C. The SIS control specimen showed a similar peak near-50° C. Accordingly, the peak near −50° C. is considered to correspond to the T_{g} derived from the I block in the SIS. The specimen of Comparative Example 3 containing no polymer other than the EP resin showed a broad peak neat −50° C. and a strong peak neat 170° C. The broad peak neat −50° C. is considered to correspond to β-relaxation of the EP resin, while the large peak neat 170° C. is considered to correspond to T_{g} derived from the EP resin. The tan & at a room temperature of 26° C. in the specimen of Comparative Example 3 was 0.022, while the tan & at a room temperature of 26° C. in the specimen of Example 39 was 0.029, showing higher value of the tan 8. This indicates that the I block, which acts as flexible rubber, contributed to stress relaxation.

### [TEM Observation]

The liquid adhesive of Example 39 was heated in an oven at 170° C. for 50 minutes, to give a thermally cured test piece. A control test piece was also prepared by solvent casting the film of the SIS¹⁹ using THF and embedding the film in the epoxy resin. These test pieces were cut into extremely thin slices with a thickness of approximately 80 nm using a microtome. To enhance the contrast of TEM image, the slices were stained overnight with osmium tetroxide vapor. The stained slices were observed under TEM using JEM1400 Flash (JEOL) at an acceleration voltage of 100 kV.

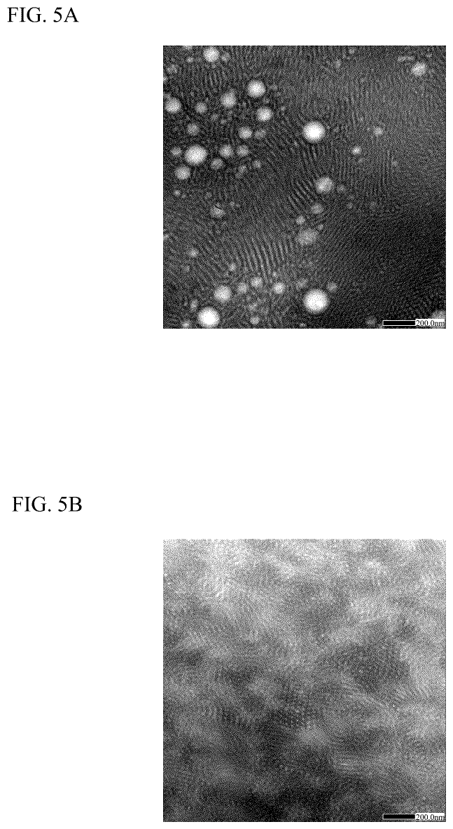

The TEM images of the cured adhesive of Example 39 and the SIS control sample are shown in FIG. 5A and FIG. 5B, respectively. Since the test pieces were stained with osmium tetroxide vapor, the I block phase appeared dark, while the S block phase and the EP resin phase appeared bright. FIG. 5B demonstrates that bright fine phases with a spherical or columnar shape (having a diameter of approximately 10-20 nm) present in dark continuous phase. It can be seen that the SIS forms nanophase-separated structure in which isolated microdomains (with a columnar or spherical shape) composed of the S blocks are dispersed within the I block matrix. FIG. 5A demonstrates that many spherical domains with a diameter of several tens to several hundreds of nanometers are present, as well as dark continuous phases and bright island-like fine phases. The bright island-like fine phases in FIG. 5A seems to be slightly larger than the bright fine phases in FIG. 5B. Since the polystyrene is compatible with the EP resin, it is considered that the fine phases composed of the S block compatible with the EP resin dispersed in the I block matrix. Since the EP was present in higher content than the SIS, it is also considered that some EP resin may remain mixed with the S block and appears as spherical domains with a diameter of several tens to several hundreds of nanometers.

### [Differential Scanning Calorimetry (DSC)]

To determine a glass transition temperature T_{g}, differential scanning calorimetry (DSC) was performed on the cured adhesives of Example 36-40 and Comparative Example 3, and the SIS. Each specimen of Examples 36-40 and Comparative Example 3 was heated in an oven at 170° C. for 50 minutes, to give a cured adhesive. The obtained specimen was put into an aluminum pan and then subjected to DSC measurement using DSC Q2000 (TA Instruments) under the conditions of a nitrogen gas flow rate of 50 min/mL, a heating rate of 10° C./min, temperatures ranging from −80 to 230° C.

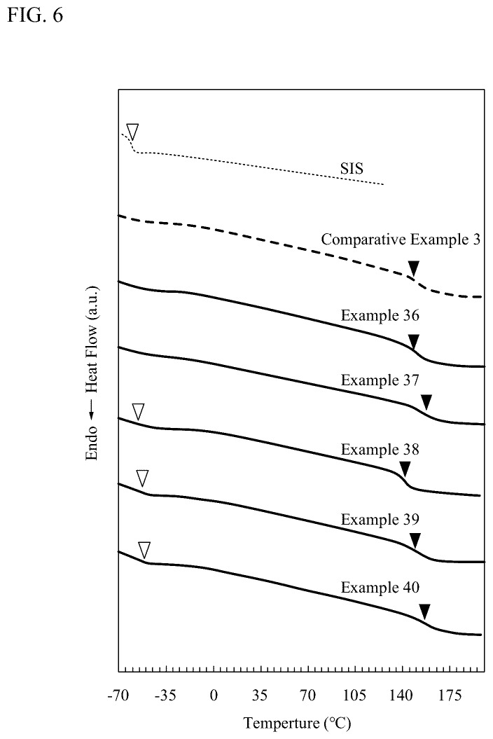

DSC thermograms of the cured adhesives of Example 36-40 containing the SIS, the cured adhesive of Comparative Example 3 containing no SIS, and SIS itself are shown in FIG. 6. In the thermograms, the open arrows (∇) show T_{g} positions derived from the rubber-like component while the solid arrows (▾) show T_{g} positions derived from the EP resin. The values of T_{g} are shown in Table. 4. In the cured adhesive specimens containing 15 parts by weight or more of the SIS, T_{g} derived from the I block were observed near −60 to −50° C. This is considered to be because the I block is incompatible with the EP resin. In the cured adhesive specimen containing less than 15 parts by weight of the SIS, T_{g} derived from the I block was not observed. This is considered to be because a step in thermograms was not detected due to low content of the I block. This phenomenon is often observed in DSC measurement of block copolymer specimens. As SIS content increased, T_{g} derived from the I block tended to be slightly higher. This is considered to be due to dissolution or reaction at the interface between the I block and the EP resin and decrease in molecular motion, but it had little to no effect. Since T_{g} near 150° C. derived from the EP resin remained unchanged regardless of SIS content, it is considered that the inclusion of SIS did not adversely affect the heat resistance of the adhesive.

This is considered to be because the I block was incompatible with the EP resin and the S block (having a T_{g} of approximately 100° C.) compatible with the EP resin was present in low content relative to the total composition, and thus the T_{g} of the EP resin was maintained.

As shown in Table 4, the adhesives of Examples 36-40 containing the SIS exhibited higher impact strength and peel strength than that of Comparative Example 3 containing no SIS. As described above, this improvement is believed that the I block provides stretchability, flexibility, and elasticity and thus toughens the epoxy resin. Specifically, the S block in the SIS is compatible with the EP resin, while the I block, which is a rubber-like polymer in the SIS, is incompatible with the EP resin. Since the S block is compatible with the EP resin, the I block is dispersed in the EP resin matrix. Such an I block acts as rubber and provides stretchability, flexibility, and elasticity, thereby toughening the epoxy resin, even after thermal curing of the EP resin. As shown in the TEM image of FIG. 5A, the spherical domains of the EP resin that were not compatible with the S block and have a diameter of several tens to several hundreds of nanometers were relatively homogeneously dispersed. This indicates that the epoxy resin was toughened.

As a reference, the inventors performed the following experiments regarding compatibility with the epoxy resin.

### Reference Example 1

In Reference Example 1, the compatibility between a 1,4-structure-rich polyisoprene having a number average molecular weight of 150,000 (hereinafter also referred to simply as “PI”), which is the hydrocarbon-based rubber-like polymer having a glass transition temperature of 25° C. or lower, and a bisphenol A type epoxy resin (which is a prepolymer, hereinafter also referred to simply as “EP resin”) was evaluated.

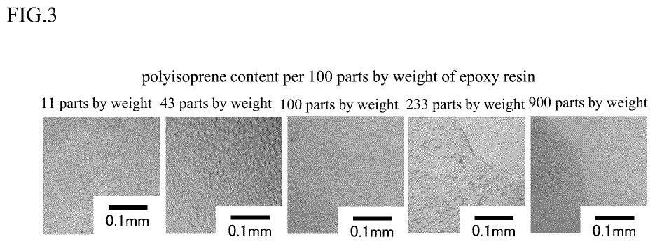

The PI, 11, 43, 100, 233, and 900 parts by weight, was weighed out and each was mixed with 100 parts by weight of the EP resin. Tetrahydrofuran (THF), which is a good solvent for both the PI and the EP resin, was added to the resultant mixtures, to prepare approximately 10 wt % solutions. Each resulting solution was dropped onto a cover glass (approximately 1 to 2 drops), followed by leaving it to stand on a hot plate heated at 40° C. to evaporate THF. Each resultant specimen was observed under an optical microscope (see FIG. 3). All specimens exhibited macro-phase separation with domain sizes of several tens to several hundreds of micrometers, showing that the PI is incompatible with the EP resin.

### Reference Example 2

In Reference Example 2, the compatibility between a polystyrene having a number average molecular weight of 11,000 available from Polymer Source Inc., product No. P41847-S (hereinafter also referred to simply as “PS1”) and the EP resin was evaluated.

In the same manner as in Reference Example 1, the PS1 was mixed with the EP resin in amounts of 11, 43, 100, 233, and 900 parts by weight relative to 100 parts by weight of the EP resin, to prepare mixtures. The resultant mixtures were observed under the optical microscope. All specimens showed homogeneous mixtures exhibiting no phase separation, showing that the PS1 is compatible with the EP resin.

### Reference Example 3

In Reference Example 3, the compatibility between a polystyrene having a number average molecular weight of 17,000 available from Polymer Source Inc., product No. P40440-S (hereinafter also referred to simply as “PS2”) and the EP resin was evaluated.

In the same manner as in Reference Example 1, the PS2 was mixed with the EP resin in amounts of 11, 43, 100, 233, and 900 parts by weight relative to 100 parts by weight of the EP, to prepare mixtures. The resultant mixtures were observed under the optical microscope. All specimens showed homogeneous mixtures exhibiting no phase separation, showing that the PS2 is compatible with the EP resin.

### Reference Example 4

In Reference Example 4, the compatibility between a polystyrene having a number average molecular weight of 24,000 available from Polymer Source Inc., product No. P1507-S (hereinafter also referred to simply as “PS3”) and the EP resin was evaluated.

In the same manner as in Reference Example 1, the PS3 was mixed with the EP resin in amounts of 11, 43, 100, 233, and 900 parts by weight relative to 100 parts by weight of the EP resin, to prepare mixtures. The resultant mixtures were observed under the optical microscope. All specimens showed homogeneous mixtures exhibiting no phase separation, showing that the PS3 is compatible with the EP resin.

### Reference Example 5

In Reference Example 5, the compatibility between a polystyrene having a number average molecular weight of 34,000 available from Polymer Source Inc., product No. P40382-S (hereinafter also referred to simply as “PS4”) and the EP resin was evaluated.

In the same manner as in Reference Example 1, the PS4 was mixed with the EP resin in amounts of 11, 43, 100, 233, and 900 parts by weight relative to 100 parts by weight of the EP resin, to prepare mixtures. The resultant mixtures were observed under the optical microscope. All specimens showed homogeneous mixtures exhibiting no phase separation, showing that the PS4 is compatible with the EP resin.

### Reference Example 6

In Reference Example 6, the compatibility between a polybutadiene having a number average molecular weight of 3,000 (hereinafter also referred to simply as “PB”) and the EP resin was evaluated.

In the same manner as in Reference Example 1, the PB was mixed with the EP resin in amounts of 11, 100, and 900 parts by weight relative to 100 parts by weight of the EP resin, to prepare mixtures. The resultant mixtures were observed under the optical microscope. All specimens exhibited macro-phase separation with domain dimensions of several tens of micrometers, showing that the PB is incompatible with the EP resin.

In the block copolymer of the present embodiment, the polymer compatible with the epoxy resin has high affinity with the epoxy resin and blended with the epoxy resin without exhibiting phase separation, whereas the hydrocarbon-based rubber-like polymer incompatible with the epoxy resin exhibits phase separation without being blended with the epoxy resin.

The one-component thermally cured epoxy adhesive composition contains the epoxy resin, the latent curing agent, and the block copolymer having the hydrocarbon-based rubber-like polymer that is incompatible with the epoxy resin and has a glass transition temperature of 25° C. or lower, and having the polymer that is compatible with the epoxy resin. The block copolymer is a thermoplastic styrenic elastomer, such as a polystyrene-polyisoprene-polystyrene block copolymer (SIS), a polystyrene-poly(ethylene-propylene)-polystyrene block copolymer (SEPS), a polystyrene-polybutadiene-polystyrene block copolymer (SBS), or a polystyrene-poly(ethylene-butylene)-polystyrene block copolymer (SEBS). In this adhesive composition, the polystyrene segment (block) in the block copolymer is compatible with the epoxy resin at room temperature.

This eliminates the formation of pseudo-cross-linking points caused by agglomeration of the polystyrene segments. Accordingly, the isoprene segment (block), the poly(ethylene-propylene) segment (block), the butylene segment (block), or the poly(ethylene-butylene) segment (block) provides flexibility, stretchability, and elasticity, thereby toughening the cured adhesive including the cured epoxy resin. As a result, the cured adhesive exhibits improved peel strength and impact strength. Furthermore, the adhesive composition allows the relief of internal stress caused by curing shrinkage and thermal shrinkage during the curing process, as well as interface stress resulting from the difference in the coefficient of thermal expansion between the adhesive and the adherend. Consequently, the cured adhesive exhibits improved durability.

The above-described examples are of one-component thermally cured epoxy resin compositions. The one-component composition, unlike two-component composition, eliminates the need for labour intensive operation such as weighing and mixing, eliminates pot life constraints, and provides the adhesive with more stable quality. Further, the one-component composition requires less space for storage.

In the above-described examples, thermoplastic styrenic elastomers were used as typical block copolymers. Alternatively, in implementing aspects of the present disclosure, a polystyrene-polyisobutylene-polystyrene block copolymer (SIBS), which is a thermoplastic elastomer having a polyisobutylene, may be employed as the block copolymer. The SIBS also enables toughening of the cured epoxy resin.

As described above, the block-copolymer-containing epoxy-based adhesive composition of the above-described embodiment contains the epoxy resin, the curing agent, and the block copolymer having the hydrocarbon-based rubber-like polymer that is incompatible with the epoxy resin and has a glass transition temperature of 25° C. or lower, and having the polymer that is compatible with the epoxy resin.

In the block-copolymer-containing epoxy-based adhesive composition of the above-described embodiment, the epoxy resin provides high adhesion. Further, since the block copolymer has the polymer compatible with the epoxy resin, the hydrocarbon-based rubber-like polymer in the block copolymer provides stretchability, flexibility, and elasticity. The epoxy adhesive composition, therefore, provides the cured adhesive with improved toughness, high peel strength and impact strength, and enhanced durability.

In the block-copolymer-containing epoxy-based adhesive composition of the above-described embodiment, the hydrocarbon-based rubber-like polymer in the block copolymer may have a monomer unit composed of isoprene, butadiene, hydrogenated isoprene, or hydrogenated butadiene, and the polymer compatible with the epoxy resin in the block copolymer may have a monomer unit having a styrene moiety, a methacrylic moiety, an acrylic moiety, or an ether moiety. Such an adhesive composition enables improvement in properties such as rubber elasticity, heat aging resistance, and weather resistance.

The styrene moiety is represented by chemical formula, —CH₂—CH(C₆H₄R)—, when R represents hydrogen or organic functional group. Examples of the styrene moiety include polystyrene, polystyrenes substituted with a C1 to C12 alkyl group, an ether group, or an ester group. Specific examples include polystyrene or styrenes such as polyacetylstyrene, polymethylstyrene, polydimethylstyrene, polybiphenylstyrene, polyphenylacetylstyrene, polyphenylstyrene, polybromoethoxystyrene, polybromomethoxystyrene, polybromostyrene, polybutoxymethylstyrene, poly-tert-butylstyrene, polybutyrylstyrene, polychlorofluorostyrene, polychloromethylstyrene, polychlorostyrene, polydichlorostyrene, polydifluorostyrene, polyethoxymethylstyrene, polycyanostyrene, polyethoxystyrene, polyfluoromethylstyrene, polyfluorostyrene, polyiodostyrene, polymethoxycarbonylstyrene, polymethoxymethylstyrene, polyanisoylstyrene, polybenzoylstyrene, polymethoxystyrene, polyperfluorostyrene, polyphenoxystyrene, polypropoxystyrene, polytolylstyrene, and polytrimethylstyrene. Among these, preferred styrene moiety is polystyrene.

The methacrylic moiety is represented by the chemical formula, —CH₂—CH(CH₃)(COOR)—, when R represents hydrogen or organic functional group. Examples of the methacrylic moiety include polymethacrylic ester such as poly(methyl methacrylate), poly(ethyl methacrylate), poly(methacrylonitrile), poly(adamantyl methacrylate), poly(benzyl methacrylate), poly(tert-butyl methacrylate), poly(tert-butylphenyl methacrylate), poly(cycloethyl methacrylate), poly(cyanoethyl methacrylate), poly(cyanomethylphenyl methacrylate), poly(cyanophenyl methacrylate), poly(cyclodecyl methacrylate), poly(cyclododecyl methacrylate), poly(cyclobutyl methacrylate), poly(cyclohexyl methacrylate), poly(cyclooctyl methacrylate), poly(fluoroalkyl methacrylate), poly(glycidyl methacrylate), poly(isobornyl methacrylate), poly(isobutyl methacrylate), poly(phenyl methacrylate), poly(trimethylsilyl methacrylate), and poly(xylyl methacrylate).

The acrylic moiety is represented by the chemical formula —CH₂—CH(COOR)—, when R represents hydrogen or organic functional group. Examples of the acrylic moiety include polyacrylic ester such as poly(adamantyl acrylate), poly(tert-butyl acrylate), poly(tert-butylphenyl acrylate), poly(cyanoheptyl acrylate), poly(cyanohexyl acrylate), poly(cyanomethyl acrylate), poly(cyanophenyl acrylate), poly(fluoromethyl acrylate), poly(methoxycarbonylphenyl acrylate), poly(methoxyphenyl acrylate), poly(naphthyl acrylate), poly(pentachlorophenyl acrylate), and poly(phenyl acrylate).

The ether moiety is represented by the chemical formula —(CH₂)ₙ—O—, when n represents a natural number of one to eight. Examples of the ether moiety include polyvinyl ethers such as poly(butoxyethylene), poly(desiloxyethylene), poly(ethoxyethylene), poly(isobutoxyethylene), poly(methoxyethylene), and poly(propoxyethylene).

The styrene moiety, the methacrylic moiety, the acryl moiety, or the ether moiety is preferably present in the polymer compatible with the epoxy resin in the block copolymer at 80 mass % or more, more preferably 90 mass % or more, and further preferably substantially 100 mass %. The polymer may include other monomer units, so long as the styrene moiety, the methacrylic moiety, the acryl moiety, or the ether moiety constitutes principal repeating units.

The block copolymer may be a thermoplastic styrenic elastomer or a hydrogenated thermoplastic styrenic elastomer. Thermoplastic styrenic elastomers or hydrogenated thermoplastic styrenic elastomers are available at low cost and has high stretchability, flexibility, and elasticity, thereby enabling improvement in toughness of the adhesive at low cost. Thus, the thermoplastic styrenic elastomer or the hydrogenated thermoplastic styrenic elastomer enables enhancement of peel strength and impact strength of the cured adhesive while keeping cost low.

In the block-copolymer-containing epoxy-based adhesive composition of the above-described embodiment, the hydrocarbon-based rubber-like polymer in the block copolymer may present in the range of 0.5 to 3000 parts by weight per 100 parts by weight of the epoxy resin. This formulation enables enhancement of toughness and durability of the cured adhesive, leading to highly reliable adhesive strength even when the adhesive composition is used for bonding dissimilar materials.

In the block-copolymer-containing epoxy-based adhesive composition of the above-described embodiment, the content of the polymer compatible with the epoxy resin in the block copolymer may be in the range of 3 to 80 mass %. This formulation allows the polymer compatible with the epoxy resin to be significantly compatible and homogenously blended with the epoxy resin, thereby providing the cured adhesive having stable properties.

In the block-copolymer-containing epoxy-based adhesive composition of the above-described embodiment, the polymer compatible with the epoxy resin in the block copolymer may have a number average molecular weight in the range of 1,000 to 5,000. Such a molecular weight allows the polymer compatible with the epoxy resin to be significantly compatible and homogenously blended with the epoxy resin, thereby providing the cured adhesive having stable properties.

In the block-copolymer-containing epoxy-based adhesive composition of the above-described embodiment, the content of the block copolymer may be in the range of 0.5 to 3500 parts by weight, per 100 parts by weight of the epoxy resin. This formulation enables combination of easy application with improvement in toughness.

In the block-copolymer-containing epoxy-based adhesive composition of the above-described embodiment, the content of the latent curing agent such as a dicyandiamide may be in the range of 1 to 20 parts by weight per 100 parts by weight of the epoxy resin. This formulation allows he epoxy resin to be cured without impairing ease of application and water resistance.

The block-copolymer-containing epoxy-based adhesive composition of the above-described examples contained the epoxy resin, the curing agent, and the block copolymer composed of the polystyrene-polyisoprene-polystyrene block copolymer (hereinafter also referred simply as “SIS”) or the hydrogenated polystyrene-polyisoprene-polystyrene block copolymer (hereinafter also referred simply as “SEPS”). In the epoxy adhesive composition of the above-described examples, the epoxy resin exhibited high adhesion and the SIS or the SEPS provided stretchability, flexibility, and elasticity, thereby providing the cured adhesive with improved toughness and high durability.

Specifically, the polystyrene segment in the SIS or the SEPS is compatible with the epoxy resin. This compatibility of the SIS or the SEPS with the epoxy resin enables the SIS or the SEPS to be finely dispersed in a matrix of the epoxy resin and thus enables the polyisoprene segment in the SIS or the hydrogenated polyisoprene segment (the ethylene-propylene segment) in the SEPS to provide stretchability, flexibility, and elasticity. As a result, the adhesive is toughened. Additionally, the internal stress caused by curing shrinkage and thermal shrinkage during the curing process, as well as the interface stress resulting from the difference in the coefficient of thermal expansion between the adhesive and the adherend, can be relieved. That is, the toughness enhancement by the SIS or the SEPS allows the stress to be effectively distributed, resulting in improved adhesive properties such as peel adhesive strength and impact adhesive strength of the cured adhesive. The cured adhesive, therefore, has high toughness and high durability.

In particular, the SIS or the SEPS enables an increase in toughness with increasing isoprene content, without impairing the inherent properties of the epoxy resin, such as adhesion, heat resistance, and thermal properties. Further, the SIS or the SEPS allows the inherent heat resistance of the epoxy resin to be maintained, providing the adhesive with a wide usable temperature range. Furthermore, since the degree of polymerization of the SIS or the SEPS can be controlled, the SIS or the SEPS can provide desired properties such as stretchability, flexibility, and elasticity by controlling the styrene content or the isoprene or hydrogenated isoprene content.

The block-copolymer-containing epoxy-based adhesive composition of the above-described examples contained the epoxy resin, the curing agent, and the block copolymer composed of the polystyrene-polybutadiene-polystyrene block copolymer (hereinafter also referred simply as “SBS”), or the hydrogenated polystyrene-polybutadiene-polystyrene block copolymer (hereinafter also referred simply as “SEBS”). In the epoxy adhesive composition of the above-described examples, the epoxy resin provided high adhesion and the SBS or the SEBS provided stretchability, flexibility, and elasticity. Consequently, the cured adhesive produced from the epoxy adhesive composition exhibited improved toughness and high durability.

Specifically, the polystyrene segment in the SBS or the SEBS is compatible with the epoxy resin. This compatibility of the SBS or the SEBS with the epoxy resin enables the SBS or the SEBS to be finely dispersed in a matrix of the epoxy resin and thus enables the polybutadiene segment in the SBS or the hydrogenated polybutadiene segment (the ethylene-butylene segment) in the SEBS to provide stretchability, flexibility, and elasticity. As a result, the adhesive is toughened. Additionally, the internal stress caused by curing shrinkage and thermal shrinkage during the curing process, as well as the interface stress resulting from the difference in the coefficient of thermal expansion between the adhesive and the adherend, can be relieved. That is, the toughness enhancement by the SBS or the SEBS allows the stress to be effectively distributed, resulting in improved adhesive properties such as peel adhesive strength and impact adhesive strength of the cured adhesive. Consequently, the cured adhesive has high toughness and high durability.

In particular, the SBS or the SEBS enables an increase in toughness with increasing butadiene content, without impairing the inherent properties of the epoxy resin, such as adhesion, heat resistance, and thermal properties. Further, the SBS or the SEBS allows the inherent heat resistance of the epoxy resin to be maintained, providing the adhesive with a wide usable temperature range. Furthermore, since the degree of polymerization of the SBS or the SEBS can be controlled, the SBS or the SEBS can provide desired properties such as stretchability, flexibility, and elasticity by controlling the styrene content or the butadiene or hydrogenated butadiene content.

The above-described description includes the disclosure of a method of producing the block-copolymer-containing epoxy-based adhesive composition. The block-copolymer-containing epoxy-based adhesive composition contains the epoxy resin, the curing agent, and the block copolymer having the hydrocarbon-based rubber-like polymer that is incompatible with the epoxy resin and has a glass transition temperature of 25° C. or lower, and having the polymer that is compatible with the epoxy resin. The method of producing the epoxy adhesive composition includes a mixing step of mixing at least the epoxy resin and the block copolymer with the solvent and a solvent removal step of removing the solvent.

The method of producing the block-copolymer-containing epoxy-based adhesive composition of the above-described embodiment produces the adhesive composition containing the epoxy resin, the curing agent, and the block copolymer having the hydrocarbon-based rubber-like polymer that is incompatible with the epoxy resin and has a glass transition temperature of 25° C. or lower, and having the polymer that is compatible with the epoxy resin. In the epoxy adhesive composition, the epoxy resin provides high adhesion. Further, since the block copolymer has the polymer compatible with the epoxy resin, the hydrocarbon-based rubber-like polymer in the block copolymer provides stretchability, flexibility, and elasticity. The cured adhesive, therefore, exhibits improved toughness, high peel strength and impact strength, and enhanced durability.

In particular, the method of producing the epoxy adhesive composition of the above-described embodiment enables the block copolymer, which has the hydrocarbon-based rubber-like polymer that is incompatible with the epoxy resin and has a glass transition temperature of 25° C. or lower, and has the polymer that is compatible with the epoxy resin, to be easily blended with the epoxy resin and homogeneously dispersed in a matrix of the epoxy resin in a short time without degrading their materials. Thus, the composition can be easily prepared.

The above description includes the disclosure of the cured epoxy adhesive containing the block copolymer. The cured epoxy adhesive containing the block copolymer is obtained by curing the epoxy adhesive composition containing the epoxy resin, the curing agent, and the block copolymer having the hydrocarbon-based rubber-like polymer that is incompatible with the epoxy resin and has a glass transition temperature of 25° C. or lower, and having the polymer that is compatible with the epoxy resin.

In the cured epoxy adhesive containing the block copolymer of the embodiment, which is formed from the epoxy adhesive composition containing the epoxy resin, the curing agent, and the block copolymer having the hydrocarbon-based rubber-like polymer that is incompatible with the epoxy resin and has a glass transition temperature of 25° C. or lower, and having the polymer that is compatible with the epoxy resin, the epoxy resin provides high adhesion. Further, since the block copolymer has the polymer compatible with the epoxy resin, the hydrocarbon-based rubber-like polymer in the block copolymer provides stretchability, flexibility, and elasticity. Consequently, the cured adhesive has improved toughness, high peel strength and impact strength, and enhanced durability.

The block-copolymer-containing epoxy-based adhesive composition of the present disclosure may be used for bonding various structural members (made of metal materials, organic polymeric materials such as plastics, or inorganic materials such as concrete) used in the field of vehicle (e.g., automobile and train including bullet train), civil engineering, construction, electronics, aircraft, and aerospace industry. It can also be used as an adhesive for medical applications, general office use, and electronic materials (e.g., interlayer adhesive for substrates such as build-up substrates in electronic devices, die bonding agents, underfills for semiconductors or ball grid array (BGA), anisotropic conductive films (ACF), anisotropic conductive pastes (ACP), thus being applicable to a wide range of fields. The epoxy adhesive composition can be applied not only to the adhesive but also to general-purpose articles, such as paints, coatings, molding materials (including sheets, films, and FRPs), insulating materials (including printed circuit boards, and wire coatings), and sealants (including potting, dipping, and transfer molding sealing for capacitors, transistors, diodes, light-emitting diodes, ICs, and LSIs, potting sealing for chip-on-board (COB), chip-on-film (COF), tape-automated bonding (TAB) of ICs, and LSIs, underfills for flip chip, or sealing for IC packaging such as quad flat packages (QFPs), ball grid array (BGAs), and chip size packages (CSPs))

The epoxy adhesive composition has high toughness imparted by the block copolymer having the hydrocarbon-based rubber-like polymer that is incompatible with the epoxy resin and has a glass transition temperature of 25° C. or lower, and having the polymer that is compatible with the epoxy resin. Such an epoxy adhesive composition is suitable for hemming adhesive or structural adhesive used in hemming portion in door and hood of automobiles or aircraft. In particular, the epoxy resin has high material strength and high adhesion. Accordingly, the cured adhesive containing the epoxy resin exhibits high durability and high impact resistance, as a result of improved toughness imparted by the block copolymer. Consequently, the epoxy adhesive composition is suitable for structural adhesive, which requires high adhesive strength such as peel strength. Improved impact resistance can also be expected to enhance safety and provide fatigue resistance. In addition, the epoxy adhesive composition may be used in various fields, such as wind turbine blades, laminated boards, sealants, electronic insulating materials, and composite materials for industrial or bicycles applications.

The scope of the present disclosure should not be limited to the above-described embodiment with respect to the epoxy adhesive composition, including its formulation, components, content, and production method. In addition, not all numeric values described in the embodiment and examples are critical. Some numeric values represent preferred values for implementing the present disclosure. A little variation is acceptable without departing from the scope and spirit of the present disclosure.

1. A block-copolymer-containing epoxy-based adhesive composition, comprising:
an epoxy resin;
a curing agent; and
a block copolymer having a hydrocarbon-based rubber-like polymer incompatible with the epoxy resin and a polymer compatible with the epoxy resin, the hydrocarbon-based rubber-like polymer having a glass transition temperature of 25° C. or lower.

2. The block-copolymer-containing epoxy-based adhesive composition according to claim 1,
wherein the hydrocarbon-based rubber-like polymer in the block copolymer has a monomer unit composed of isoprene, butadiene, hydrogenated isoprene, or hydrogenated butadiene; and
the polymer compatible with the epoxy resin in the block copolymer has a monomer unit with a styrene moiety, a methacrylic moiety, an acryl moiety, or an ether moiety.

3. The block-copolymer-containing epoxy-based adhesive composition according to claim 1,
wherein the hydrocarbon-based rubber-like polymer in the block copolymer is present in an amount of 0.5 to 3000 parts by weight relative to 100 parts by weight of the epoxy resin.

4. The block-copolymer-containing epoxy-based adhesive composition according to claim 1,
wherein the polymer compatible with the epoxy resin in the block copolymer is present in an amount of 3 to 80 mass %.

5. The block-copolymer-containing epoxy-based adhesive composition according to claim 1,
wherein the polymer compatible with the epoxy resin in the block copolymer has a number average molecular weight of 1,000 to 50,000.

6. The block-copolymer-containing epoxy-based adhesive composition according to claim 1,
wherein the block copolymer is present in an amount of 0.5 to 3500 parts by weight per 100 parts by weight of the epoxy resin.

7. The block-copolymer-containing epoxy-based adhesive composition according to claim 1,
wherein the block copolymer comprises a thermoplastic styrenic elastomer or a hydrogenated thermoplastic styrenic elastomer.

8. A block-copolymer-containing epoxy-based adhesive composition, comprising:
an epoxy resin;
a curing agent; and
a polystyrene-polyisoprene-polystyrene block copolymer or a hydrogenated product of the polystyrene-polyisoprene-polystyrene block copolymer.

9. A block-copolymer-containing epoxy-based adhesive composition, comprising:
an epoxy resin;
a curing agent; and
a polystyrene-polybutadiene-polystyrene block copolymer or a hydrogenated product of the polystyrene-polybutadiene-polystyrene block copolymer.

10. A method for producing a block-copolymer-containing epoxy-based adhesive composition, the method comprising:
mixing at least two components, an epoxy resin and a block copolymer, with a solvent; and
removing the solvent,
wherein the block-copolymer-containing epoxy-based adhesive composition contains the epoxy resin, a curing agent, and the block copolymer having a hydrocarbon-based rubber-like polymer incompatible with the epoxy resin and a polymer compatible with the epoxy resin, the hydrocarbon-based rubber-like polymer having a glass transition temperature of 25° C. or lower.

11. A cured block-copolymer-containing epoxy-based adhesive prepared by curing a block-copolymer-containing epoxy-based adhesive composition containing an epoxy resin, a curing agent, and a block copolymer having a hydrocarbon-based rubber-like polymer incompatible with the epoxy resin and a polymer compatible with the epoxy resin, the hydrocarbon-based rubber-like polymer having a glass transition temperature of 25° C. or lower.
